(19) United States
(12) Patent Application Publication
(10) Pub. No.: US 2024/0201560 A1
(43) Pub. Date: Jun. 20, 2024

(54) RADIATION FIELD PROVISION DEVICE

(71) Applicant: Universitaet Stuttgart, Stuttgart (DE)

(72) Inventors: Christoph Roecker, Weil der Stadt (DE); Pascal Weinert, Stuttgart (DE); Uwe Brauch, Stuttgart (DE); Marwan Abdou Ahmed, Stuttgart (DE)

(21) Appl. No.: 18/394,311

(22) Filed: Dec. 22, 2023

Related U.S. Application Data
(63) Continuation of application No. PCT/EP2022/067272, filed on Jun. 23, 2022.

(30) Foreign Application Priority Data
Jun. 24, 2021 (DE) 10 2021 116 391.9

(51) Int. Cl. G02F 1/35

(52) U.S. Cl. CPC G02F 1/3544; G02F 1/3503

(57) ABSTRACT

Proposed is a radiation field provision device, in which in particular an optical path for a radiation field is defined, comprising a frequency conversion body, wherein the frequency conversion body is partially formed from a frequency-converting medium and a reflector.

### CROSS-REFERENCE TO RELATED PATENT APPLICATION

This application is a continuation of international application number PCT/EP2022/067272, filed on Jun. 23, 2022 and claims the benefit of German application No. 10 2021 116 391.9 filed on Jun. 24, 2021, which are hereby incorporated in their entirety by reference thereto for all purposes.

### BACKGROUND OF THE INVENTION

The invention relates to a radiation field provision device in which, in particular, an optical path for a radiation field is defined.

### SUMMARY OF THE INVENTION

The object of the invention is to improve a radiation field provision device.

According to one aspect of the invention, this object is achieved in that the radiation field provision device comprises a frequency conversion body, wherein the frequency conversion body is partially formed from a frequency-converting medium and a reflector.

For example, one advantage of the invention is that the frequency-converting medium subjects an incident radiation field to a frequency conversion and the reflector integrated in the frequency conversion body enables a compact construction.

In particular, one advantage of the invention is that there is provided at the reflector, behind the reflector, a free installation space which is not irradiated by the radiation field and in which parts of the radiation field provision device, such as a holder and/or parts of a cooling system, can thus be arranged without influencing the radiation field.

Preferably, in the device according to the invention, heat which is generated, for example, by parasitic effects in the frequency conversion body, can be substantially dissipated by a heat sink arranged behind the reflector in relation to a propagation direction of the radiation field.

Advantageously, a temperature gradient in the irradiated region of the frequency conversion body is oriented at least approximately in the same direction and thus thermally induced interference is at least reduced.

In particular, substantially the entire lateral extent of the frequency conversion body can be used for cooling for a heat sink behind the reflector without negatively influencing the propagation of the radiation field, wherein the cooling of the frequency conversion body is improved by a short distance from the heat sink to the irradiated region of the frequency conversion body and the large cooling area.

Preferably, this reduces negative thermal effects in the frequency conversion body and, in particular, improves the efficiency of the frequency conversion and, for example, has less of a negative impact on the quality of the radiation field, preferably substantially maintaining it.

In particular, this makes the radiation field provision device especially favorable for pulsed radiation fields, for example pulsed lasers with high peak power densities and/or with high average power.

For example, one advantage of the invention is that the double pass through the frequency conversion body means that this can be made thinner and thermal inhomogeneities can be reduced as a result.

No further details have yet been provided with regard to the frequency conversion in the frequency conversion body.

In particular, at least if the required and adapted conditions are present, a radiation field is subject in the frequency-converting medium to a frequency conversion, in which a radiation field component is at least partially converted into another radiation field component with a different frequency.

In particular, it is provided that, in the case of a radiation field propagating along the optical path, a radiation field component in the frequency-converting medium of the frequency conversion body which is involved in a frequency conversion is at least partially converted by the frequency conversion into a radiation field component with a different frequency before it impinges, in particular directly, on the frequency conversion body.

In particular, the frequency conversion takes place in the frequency conversion body after the radiation field component impinges on the frequency conversion body and before the radiation field component leaves the frequency conversion body.

For example, during the frequency conversion, at least one component of the radiation field is used to generate at least one other component that has a higher frequency than the starting component.

In particular, the frequency of at least one component of the radiation field is multiplied during the frequency conversion, in particular the frequency of the component(s) is doubled and/or tripled.

In some preferred embodiments, at least one other component with a lower frequency is generated from at least one component of the radiation field during the frequency conversion.

The frequency conversion takes place in particular through non-linear processes in the frequency conversion body.

In particular, the frequency conversion is a macroscopic process that takes place through constructive interference of microscopic processes.

For example, it is provided that at least one portion of the optical path runs within the frequency conversion body. In particular, a radiation field propagating along the optical path is thus subject to a frequency conversion at least partially along this portion.

In particular, the portion of the optical path running in the frequency conversion body comprises one or more branches.

For example, the radiation field radiated into the frequency conversion body interacts with it along at least one branch within the frequency conversion body, so that a frequency conversion and/or a reflection of the radiation field occurs due to this interaction.

In some favorable embodiments, it is provided that the radiation field penetrates into the frequency conversion body along at least one branch.

In some advantageous embodiments, it is provided that an evanescent field of the radiation field is formed along at least one branch of the optical path in the frequency conversion body.

In some preferred embodiments, it is provided that at least along one branch in the frequency conversion body, the radiation field propagates in a waveguide structure.

In some advantageous embodiments, it is provided that the portion of the optical path running in the frequency conversion body comprises an incident branch, which in particular impinges on the reflector, and a reflected branch, wherein in particular the incident branch transitions into the reflected branch at the reflector.

In particular, it is provided that a frequency conversion takes place along at least one branch of the portion of the optical path running in the frequency conversion body in the case of a radiation field propagating along the optical path.

In some advantageous embodiments, it is provided that frequency conversion takes place at least along the reflected branch. Thus, advantageously, the propagation of the radiation field after reflection in the frequency conversion body is utilized to achieve the frequency conversion.

In particular, the reflected branch of the optical path in the frequency conversion body is therefore aligned in such a way that the necessary conditions for the processes that cause the frequency conversion are fulfilled along this branch.

In some preferred embodiments, it is provided that frequency conversion takes place at least along the incident branch. In this way, the propagation of the radiation field in the frequency conversion body prior to reflection is advantageously utilized in order to achieve a frequency conversion in the radiation field.

In particular, the incident branch of the optical path is aligned in the frequency conversion body in such a way that the necessary conditions for the processes causing the frequency conversion are fulfilled along this branch.

Preferably, the frequency conversion takes place along the incident branch and along the reflected branch, so that the frequency conversion takes place along a long portion of the optical path and thus a high rate for the frequency conversion is achieved.

In other advantageous embodiments, it is provided that no frequency conversion takes place along at least one branch of the optical path in the frequency conversion body, in particular along the incident branch.

In particular, in these embodiments, the at least one branch, for example the incident branch, in the frequency conversion body is thus aligned in such a way that the necessary conditions for the processes causing the frequency conversion are not fulfilled along this branch, and thus no frequency conversion takes place.

In particular, there is no frequency conversion on the entire sub-portion of the optical path that extends from the entry of the optical path into the frequency conversion body to the reflector.

Preferably, this allows the radiation field provision device to be formed structurally more simply, since, for example, the at least one branch, in particular the incident branch, does not have to be suitably aligned to fulfil the conditions necessary for the processes causing the frequency conversion.

In particular, the radiation field provision device can be designed to be structurally simpler, as only the starting components of the radiation field need to be reflected at the reflector and it is not necessary to ensure that the frequency-converted components are also reflected. In particular, there is no requirement for the reflector to reflect the starting components and the frequency-converted components in a phase-matched manner. For example, this requirement must otherwise be fulfilled in order to avoid a re-conversion after reflection.

No further details have yet been provided regarding the frequency-converting medium.

In particular, the frequency-converting medium is an optically non-linear and/or optically anisotropic medium.

In preferred embodiments, it is provided that the frequency-converting medium is formed by a crystal, in particular an optically non-linear and/or optically anisotropic crystal.

For example, the crystal is beta-barium borate (BBO) and/or lithium triborate (LBO) and/or cesium-lithium borate (CLBO) and/or potassium diphosphate (KDP) and/or lithium niobate (LNB).

In advantageous embodiments, a photonic crystal forms the frequency-converting medium.

In particular, the photonic crystal has a one-dimensional or two-dimensional or three-dimensional periodic structure.

In particular, the frequency-converting medium of the frequency conversion body has at least one marked axis.

The frequency conversion, in particular macroscopic frequency conversion, takes place here in a radiation field that propagates at a frequency conversion angle to the marked axis.

In some favorable embodiments, the frequency conversion angle is 0°.

In other advantageous embodiments, the frequency conversion angle is different from 0°, i.e. in particular greater than 0° and less than or equal to 90°.

In particular, the frequency-converting medium has a plurality of frequency conversion angles, in particular differing only slightly, which lie within a frequency conversion angle band.

In particular, frequency conversion takes place here in the frequency-converting medium for a radiation field of which the radiation field components involved in a frequency conversion propagate at one of the frequency conversion angles lying in the frequency conversion angle band to the marked axis, wherein the necessary conditions for macroscopic frequency conversion are fulfilled at these frequency conversion angles.

For example, several of the radiation field components involved in the frequency conversion propagate at the same frequency conversion angle.

In some preferred embodiments, several of the radiation field components involved in the frequency conversion propagate at different frequency conversion angles.

For example, frequency conversion takes place with a higher efficiency at frequency conversion angles that lie in a center of the frequency conversion angle band than at frequency conversion angles that lie at an edge of the frequency conversion angle band.

For example, the frequency conversion angle band comprises at least angles in an angle range of up to 5°, in particular up to 2°, for example up to 1°.

For example, radiation fields that propagate at an angle outside the frequency conversion angle band with respect to the marked axis can still undergo frequency-converting processes on a microscopic scale, but the other necessary conditions for the frequency conversion, in particular macroscopic frequency conversion, are not present, so that no or at least no efficient frequency conversion takes place for these radiation fields.

In particular, in some embodiments, the marked axis is an optical axis of the frequency conversion body.

In some favorable embodiments, the marked axis is a main axis of the refractive index ellipsoid of the frequency-converting medium.

In some advantageous embodiments, the marked axis is an axis of a grating vector of the frequency-converting medium.

In embodiments with a crystal forming the frequency-converting medium, the marked axis is in particular a crystal axis of the crystal.

In some advantageous embodiments, it is provided that the incident branch and the reflected branch run symmetrically with respect to the marked axis.

In particular, it is provided that the two branches run at a frequency conversion angle to the marked axis.

For example, this makes it possible to realize a geometry of simple form in the radiation field provision device.

In particular, this ensures that frequency conversion takes place both along the incident branch and along the reflected branch, thus achieving a high rate of frequency conversion.

Preferably, the conditions for frequency conversion are fulfilled here at least along these branches and in particular along at least the majority of the portion of the optical path running in the frequency conversion body, and a re-conversion is at least largely avoided.

In other advantageous embodiments, it is provided that the incident branch and the reflected branch run asymmetrically in relation to the marked axis. In particular, the two branches run at different angles relative to the marked axis.

For example, one advantage of this is that the asymmetrical alignment of the two branches means that different processes take place along them and/or a process that takes place along one branch does not take place along the other branch.

Preferably, it is provided that at least one branch, in particular the reflected branch, runs at a frequency conversion angle relative to the marked axis, so that the processes causing the frequency conversion, in particular macroscopic frequency conversion, take place along this branch.

In particular, it is provided that at least one branch, for example the incident branch, runs at an angle to the marked axis which deviates from a frequency conversion angle and/or lies outside the frequency conversion angle band, so that the processes causing the frequency conversion do not take place along this branch, at least not on a macroscopic scale.

Preferably, this simplifies the form of the device structurally, for example because the reflector does not have to reflect the radiation field components under special conditions.

In particular, along this branch as well, which runs at an angle that deviates significantly from the frequency conversion angle and/or lies outside the frequency conversion angle band, at least substantially no re-conversion can take place.

No further details have yet been provided regarding the form of the reflector.

In particular, it is provided that a radiation field propagating along the optical path is reflected by the reflector after it strikes the frequency conversion body, in particular directly, and before it leaves the frequency conversion body, in particular directly.

In particular, the frequency conversion body has an entry side at which the optical path enters the frequency conversion body.

In particular, a radiation field propagating along the optical path enters the frequency conversion body on the entry side.

In particular, the frequency conversion body has an exit side at which the optical path exits from the frequency conversion body.

In particular, a radiation field propagating along the optical path exits from the frequency conversion body on the exit side.

In advantageous embodiments, it is provided that the reflector is at least partially formed on a side of the frequency conversion body that is opposite a side forming the entry side and/or the exit side.

In particular, it is therefore provided that a radiation field irradiated onto the frequency conversion body enters the frequency conversion body on the entry side and is propagated along the portion of the optical path running in the frequency conversion body, in particular along the incident branch, until it reaches the reflector and is reflected on the reflector and is further propagated along the portion running in the frequency conversion body, in particular along the reflected branch, in the frequency conversion body, until it exits from the frequency conversion body at the exit side.

In particular, it is envisaged here that the incident branch and/or reflected branch run/runs through the frequency-converting medium.

In some favorable embodiments, it is provided that the reflector is at least partially formed on the side of the frequency conversion body forming the entry side and/or the exit side.

For example, a radiation field propagating along the optical path interacts with part of the reflector on the entry side and at least part of the radiation field, for example an evanescent field, enters the frequency-converting medium, so that the frequency conversion takes place there, and by coupling the frequency-converted radiation field component with the radiation field component interacting with the reflector, the reflected radiation field comprises at least one frequency-converted radiation field component.

In particular, modes which interact with the part of the reflector formed on the entry side and/or exit side and modes which interact with the frequency-converting medium are coupled here in such a way that the reflected radiation field comprises at least one frequency-converted radiation field component.

In particular, it is provided that the frequency-converting medium, in particular a part of the frequency conversion body formed from the frequency-converting medium, has a reflector side.

In particular, the reflector is at least partially formed on the reflector side of the frequency-converting medium.

In some preferred embodiments, it is provided that the reflector is arranged on the reflector side of the frequency-converting medium.

In some advantageous embodiments, it is provided that the reflector is attached to the frequency-converting medium, in particular to its reflector side.

For example, the reflector is bonded to the frequency-converting medium.

In some preferred embodiments, it is provided that the reflector is at least partially formed from the frequency-converting medium.

For example, a grating structure of the reflector, which in particular is explained in greater detail below, is at least partially formed from the frequency-converting medium.

In some advantageous embodiments, it is provided that the entry side and/or exit side of the frequency conversion body is formed from the frequency-converting medium.

In particular, the reflector is formed and/or arranged on a side of the part of the frequency conversion body formed from the frequency-converting medium opposite the side forming the entry side and/or the exit side.

It is preferably provided that the reflector has an at least substantially flat reflection surface.

In particular, the at least substantially flat reflection surface is flat or has a radius of curvature that is greater than 0.5 m, preferably greater than 1 m, in particular greater than 2 m, for example greater than 8 m.

In particular, a radiation field propagating along the optical path is reflected relative to the reflection surface, which in particular is at least substantially flat.

In particular, it is provided that a radiation field propagating along the optical path is reflected at least on a macroscopic scale relative to the reflection surface.

Preferably, this ensures that a radiation field propagating along the optical path is reflected at the reflector, but a beam geometry of the radiation field, for example a collimated radiation field, is at least substantially retained during reflection.

A slight curvature of the reflector, in particular the reflection surface, is favorable, for example, for connecting, in particular bonding, the reflector to the part formed from the frequency-converting medium.

For example, the at least substantially flat reflection surface extends substantially in a geometric reflection plane.

In some preferred embodiments, the reflection surface, in particular the geometric reflection plane, is aligned symmetrically with respect to the marked axis in such a way that both the incident branch and the reflected branch run at a frequency conversion angle, i.e. in particular at an angle of the frequency conversion angle band, with respect to the marked axis.

For example, it is provided that the reflection surface, in particular the geometric reflection plane, runs at least approximately perpendicular to the marked axis.

In other favorable embodiments, the marked axis runs obliquely to the reflection surface, in particular to the reflection plane, but symmetrically in such a way that the incident branch and the reflected branch run at a frequency conversion angle to the marked axis.

For example, the marked axis runs here in a symmetry plane which is perpendicular to a plane in which the incident branch and the reflected branch run and which contains the normal of the reflection surface in relation to which the angle of incidence of the incident branch and the angle of reflection of the reflected branch are measured.

This ensures, for example, that the optical conditions are at least substantially the same for both the incoming and outgoing branches, in particular that the processes causing the frequency conversion can run efficiently along both branches and that the macroscopic frequency conversion in particular takes place.

In other advantageous embodiments, it is provided that the reflection surface, in particular the geometric reflection plane, is asymmetrical with respect to the marked axis in such a way that different optical conditions exist along the incident branch and along the reflected branch.

In particular, the reflection surface, in particular the geometric reflection plane, runs asymmetrically with respect to the marked axis in such a way that one branch of the optical path, in particular the reflected branch, runs at a frequency conversion angle, i.e., in particular at an angle within the frequency conversion angle band, with respect to the marked axis and the other branch, for example the incident branch, runs at an angle with respect to the marked axis which is different from a frequency conversion angle and/or lies outside the frequency conversion angle band in such a way that the necessary conditions for the processes causing the frequency conversion, in particular macroscopic frequency conversion, are not fulfilled along this branch.

Preferably, this makes it possible to provide the device in a structurally simpler form so that, for example, the reflector does not have to reflect the radiation field components under conditions specially adapted to the frequency conversion.

For example, it can also be achieved that frequency conversion takes place along one branch and frequency conversion and/or re-conversion is at least largely prevented along the other branch.

In particular, the course of the optical path through the frequency conversion body, in particular by aligning the incident branch and/or the reflected branch and/or the reflection surface, is such that undesired processes, in particular parasitic processes such as absorption and/or processes causing undesired frequency conversion, are reduced, in particular suppressed as far as possible.

It is particularly advantageous if the reflector provides a reflected radiation field, in particular on the reflected branch, in which the radiation field components involved in the frequency conversion fulfil conditions adapted to the frequency conversion.

In particular, conditions adapted to the frequency conversion at least largely suppress re-conversion and/or undesired oscillation between the radiation field components.

In particular, it is provided that the reflector provides a reflected radiation field in which the radiation field components involved in the frequency conversion have a phase relationship to one another that is adapted to the frequency conversion.

This preferably ensures that the frequency conversion can take place along the reflected branch, for example.

In particular, undesired oscillations between the radiation field components and/or a re-conversion of already frequency-converted radiation field components are at least reduced, preferably at least approximately suppressed, by conditions adapted to the frequency conversion, in particular an adapted phase relationship.

In particular, it is provided that the reflector is formed in such a way that a phase relationship between at least the radiation field components involved in the frequency conversion remains at least approximately unchanged by the reflector, wherein in particular reflected radiation field components of incident radiation field components with phase relationships to one another that are required and/or adapted for the frequency conversion also have a phase relationship to one another that is required and/or adapted for the frequency conversion.

In particular, the reflector thus impairs the frequency conversion of the radiation field components to at most a small extent, preferably the reflector impairs the frequency conversion imperceptibly.

This property of the reflector is particularly favorable in embodiments in which the frequency conversion takes place along the incident branch and the reflected branch, as the frequency conversion is then substantially not disturbed by the reflector.

The reflector can be formed in a wide range of different ways.

In some advantageous embodiments, it is provided that the reflector comprises a dielectric mirror, for example in the form of a dielectric mirror.

In particular, the reflector comprises multiple layers. Preferably, it is made up of this multiplicity of layers.

It is particularly favorable if the layers are dielectric layers.

In some preferred embodiments, at least one layer is, preferably at least some of the layers are formed from an amorphous material.

For example, at least one layer is, preferably at least some layers are formed from SiO₂ and/or Ta₂O₅ and/or HfO₂ and/or Al₂O₃ and/or Nb₂O₅ and/or TiO₂.

It is advantageous if at least one layer, preferably at least some of the layers, are formed of a crystalline material.

For example, at least one layer is, or at least some layers are formed from GaAs/AlAs, in particular as a crystalline layer. These have particularly advantageous optical and/or thermal properties.

For example, at least some of the layers are formed from Sc₂O₅ and/or Lu₂O₃ and/or LuScO₃.

In some favorable embodiments, the reflector has at least one metallic layer. Preferably, the metallic layer is arranged on one side of the frequency conversion body opposite the side forming the entry side and/or the exit side.

In particular, the metallic layer supports the reflective property of the reflector.

For example, the metallic layer has good thermal conductivity and therefore improves heat dissipation.

In particular, the metal layer arranged on the opposite side to the incident side enables a particularly favorable connection of the reflector to another body, in particular to a cooling body, for example by metallic bonding. Advantageously, this enables a connection which has a low thermal resistance.

In particular, the multiplicity of layers comprises at least one layer assembly in which the layers preferably have alternately a high and a low refractive index.

In some advantageous embodiments, it is provided that the multiplicity of layers comprises only one layer assembly, in particular is constructed from this one layer assembly.

This means, for example, that the structure of the one layer assembly allows an incoming radiation field, which in particular has only one relevant radiation field component, to be reflected by the reflector, which is formed in particular in such a way that this one relevant radiation field component is reflected highly efficiently.

In particular, it is provided here that the radiation field, in particular the one relevant radiation field component, is subjected to the frequency conversion along the reflected branch.

For example, the reflector formed of just one layer assembly offers a structurally simple solution.

In other preferred embodiments, it is provided that the reflector has a plurality of layer assemblies, wherein in particular each of the layer assemblies is configured to reflect one or more radiation field components of the radiation field components involved in the frequency conversion.

For example, the reflector has a layer assembly reflecting this radiation field component for each incident radiation field component involved in the frequency conversion.

In other advantageous embodiments, the reflector has at least one layer assembly which is reflective for at least two of the radiation field components involved in the frequency conversion.

With this solution it is thus realized that all radiation field components involved in the frequency conversion are also reflected by the reflector and are therefore available on the reflected branch.

In particular, one layer assembly in each case is configured to reflect at least one radiation field component involved in the frequency conversion, preferably highly efficiently, i.e. in particular to reflect to an extent of at least 95%, preferably to reflect to an extent of at least 99%, for example to reflect to an extent of at least 99.5%.

For example, at least some layers, in particular the layers of a respective layer assembly, each have a thickness such that the optical path length through this layer corresponds at least approximately to a quarter of a wavelength of a radiation field component to be reflected.

In particular, this achieves a particularly good reflection of the corresponding radiation field component.

It is particularly advantageous if the reflector comprises at least one layer for phase matching of at least one radiation field component involved in the frequency conversion.

Thus, at least one layer is configured to adjust the phase of at least one radiation field component involved in the frequency conversion and thus, for example, to compensate for a phase shift in this radiation field component, in particular relative to other radiation field components involved in the frequency conversion, wherein, for example, the phase shift is induced by the passage of this radiation field component through other parts of the reflector.

Preferably, this ensures that several radiation field components involved in the frequency conversion version relative to one another have a phase relationship to one another that is adapted to the frequency conversion after reflection by the reflector, in particular in order to at least reduce, preferably largely suppress, a re-conversion in the reflected radiation field.

Preferably, the reflector has a plurality of layers for phase matching of a radiation field component involved in the frequency conversion.

In particular, the reflector has a corresponding layer that effects the phase matching for all but one of the radiation field components involved in the frequency conversion.

It is preferably provided that the layers of the reflector extend at least approximately parallel to a reflection surface of the reflector.

In advantageous embodiments, one or more layers of the reflector, which is/are formed in particular as explained above, is/are formed on a side of the frequency conversion body which is opposite the side forming the entry side and/or exit side.

In some particularly preferred embodiments, it is provided that the reflector comprises at least one optical grating.

In particular, this provides a particularly efficient reflector.

For example, the at least one optical grating offers a wide range of options for specifically setting the reflection properties.

In particular, the one optical grating or plurality of optical gratings are formed in the sub-wavelength range of the radiation field.

For example, a grating constant and/or a period of the at least one optical grating is smaller than the wavelengths of the radiation field components, in particular smaller than half of these wavelengths.

In particular, the reflector comprises at least one layer, i.e., one or more layers, which has/have a grating structure forming the optical grating.

In some favorable embodiments, it is provided that an optical grating is formed on the side of the frequency conversion body forming the entry side and/or exit side.

In advantageous embodiments, an optical grating is arranged on a reflector side of the part of the frequency conversion body formed from the frequency-converting medium.

In particular, an optical grating is arranged on a side of the part formed from the frequency-converting medium which is opposite the side forming the entry side and/or exit side.

In some preferred embodiments, it is provided that at least one coating is arranged between the reflector side of the part formed from the frequency-converting medium facing the reflector and the at least one layer forming a grating structure.

Preferably, the at least one coating is an at least partially reflective coating which is reflective at least for a radiation field component involved in the frequency conversion.

For example, the at least one coating comprises one or more layers, in particular at least one layer assembly, with one or more of the features described above.

For example, it is provided that a field component transmitting the coating and/or an evanescent field of the radiation field passes through the at least one layer forming a grating structure, in particular if the at least one coating is arranged between the frequency-converting medium and the at least one layer forming the grating structure.

In some advantageous embodiments, it is provided that at least one buffer layer is arranged between the, in particular, at least partially reflective coating and the at least one layer forming the grating structure.

In particular, the buffer layer decouples the excitation of modes in the at least one layer forming the grating structure and excitations of modes in the coating.

Preferably, the buffer layer has a low refractive index.

For example, the buffer layer has such a thickness that the optical path length through it for at least one radiation field component involved in the frequency conversion is at least approximately in the range from half the wavelength to one wavelength, in particular the optical path length corresponds at least approximately to half the wavelength or one wavelength.

In other advantageous embodiments, it is provided that the frequency-converting medium, for example on the reflector side, at least partially forms the grating structure of the optical grating.

In particular, the reflector side is structured according to the grating structure.

Preferably, it is provided here that at least one layer, i.e. one or more layers, is arranged on the structured reflector side, in which the grating structure of the reflector side is continued.

For example, at least one coating, in particular an unstructured coating, preferably with one or more of the features described above, is provided on the side of the reflector facing away from the frequency-converting medium.

In some preferred embodiments, the structured layers form the side of the frequency conversion body opposite the side forming the entry side and/or exit side.

For example, the structured layers are arranged directly on a substrate supporting the reflector or directly on a cooling body.

It is particularly favorable if at least one optical grating forms a waveguide for at least one radiation field component involved in the frequency conversion.

In particular, at least one optical grating is configured to effect, in the reflected radiation field, a phase matching between the radiation field components that is required and/or adapted for the frequency conversion.

For example, a waveguide mode is excited in at least one optical grating, the feedback of which waveguide mode into the reflected radiation field causes the adapted and/or required phase matching for at least one radiation field component.

In some advantageous embodiments, it is provided that at least one optical grating is reflective for at least one radiation field component involved in the frequency conversion.

No further information has yet been provided regarding further details of the part of the frequency conversion body formed from the frequency-converting medium, in particular its geometric form.

Preferably, it is provided that the reflector is arranged at least partially on the reflector side of the part formed from the frequency-converting medium.

In particular, the reflector side has, for example, a flat intermediate surface, on one side of which the frequency-converting medium is arranged and on the other side of which the reflector is arranged. In particular, the intermediate surface of the reflector side runs at least substantially in a geometric plane.

For example, this results in a structurally simple form of the frequency conversion body, which is easily realized, in particular for thin frequency conversion bodies.

In particular, a reflector with a flat reflection surface can be arranged particularly favorably, in particular directly, on the flat intermediate surface of the reflector side.

In some advantageous embodiments, the preferably flat intermediate surface of the reflector side runs at least approximately perpendicular to the marked axis of the frequency-converting medium.

For example, this is favorable for embodiments in which the incident branch and the reflected branch are at least approximately symmetrical to the marked axis, since a reflector with a reflection surface that runs at least approximately perpendicular to the marked axis can be arranged particularly favorably on the intermediate surface of the reflector side that is at least approximately perpendicular to the marked axis.

In other favorable embodiments with a preferably flat intermediate surface on the reflector side, which runs at least approximately perpendicular to the marked axis of the optical medium, the incident branch and the reflected branch run asymmetrically to the marked axis, wherein this is realized in particular by a reflector comprising a grating. In particular, the grating here has a grating structure so that the angle of incidence of the radiation field along the incident branch is not equal to the angle of reflection of the radiation field along the reflected branch.

In yet other preferred embodiments, it is provided that the preferably flat intermediate surface on the reflector side runs obliquely to the marked axis.

For example, in a favorable way a reflector with a reflection surface that runs obliquely to the marked axis can be arranged particularly favorably on this intermediate surface. This configuration can be advantageous, for example, if the incident branch and the reflected branch are to run at different angles to the marked axis or are to run at the same angle to the marked axis, as explained in conjunction with the reflection surface.

No further details have yet been provided regarding the entry side and exit side.

Preferably, the incident branch runs from the entry side directly to the reflector.

In particular, this means that after entering the frequency conversion body, the radiation field immediately propagates along the incident branch in a straight line to the reflector and preferably passes through the frequency-converting medium at least in portions.

In particular, the radiation field is not reflected within the frequency conversion body between entering the frequency conversion body and impinging on the reflector.

Preferably, the reflected branch runs directly from the reflector to the exit side.

In particular, this means that, after reflection at the reflector, the radiation field propagates along the reflected branch in a straight line to the exit side and preferably passes through the frequency-converting medium at least in portions.

In particular, the radiation field between the reflector and the exit from the frequency conversion body is not reflected again within the frequency conversion body on the exit side.

For example, in some embodiments, the entry side and the exit side are different sides of the frequency conversion body.

Preferably, the same side of the frequency conversion body forms both the entry side and the exit side.

In some preferred embodiments, it is provided that a surface of the frequency conversion body on the entry side and/or a surface of the frequency conversion body on the exit side runs/runs at least approximately parallel to the intermediate surface on the reflector side.

In particular, this provides a structurally simple solution for forming the frequency conversion body. In particular, the solution is particularly favorable for a thin frequency conversion body.

In some advantageous embodiments, at least the surface of the frequency conversion body on the entry side and/or at least the surface of the frequency conversion body on the exit side runs at least approximately perpendicular to the marked axis of the frequency-converting medium of the frequency conversion body.

In some preferred embodiments, it is provided that at least the surface of the frequency conversion body on the entry side and/or at least the surface of the frequency conversion body on its exit side runs obliquely to the marked axis of the frequency-converting medium of the frequency conversion body.

In some advantageous embodiments, it is provided that the surface of the frequency conversion body on its entry side and the surface of the frequency conversion body on its exit side run substantially in the same geometric plane.

Preferably, the common geometric plane of the entry side and exit side runs at least substantially parallel to the geometric plane of the intermediate surface of the reflector side.

In particular, this provides a geometrically simple form of the frequency conversion body and this can be manufactured cost-effectively. This embodiment is particularly advantageous for a thin frequency conversion body.

In other advantageous embodiments, it is provided that the surface of the frequency conversion body on its entry side and the surface of the frequency conversion body on its exit side run obliquely to one another. For example, the surfaces running obliquely to one another are aligned in such a way that losses, in particular reflection losses, are at least reduced at these surfaces when the radiation field propagating along the optical path enters or exits.

In particular, the obliquely running surfaces can be aligned to avoid total reflection and/or in such a way that the conditions for frequency conversion are met along the refracted optical path, in particular along the incident branch and/or along the reflected branch.

In some particularly advantageous embodiments, it is provided that the frequency conversion body has a coating on at least one surface. In particular, it has a coating on its entry side and/or on its exit side.

In particular, this coating is an anti-reflection coating.

Preferably, this at least reduces losses and/or interference in the radiation field propagating along the optical path when entering and/or exiting the frequency conversion body.

No further details have yet been provided regarding the embodiment of the frequency conversion body.

Preferably, the frequency conversion body is a thin body.

In particular, an extent of the frequency conversion body between the side forming the entry side and/or exit side and an opposite side is smaller, for example significantly smaller, than a lateral extent of these sides.

In particular, the lateral extent of the thin frequency conversion body, in particular along the side forming the entry side and/or exit side and/or along the opposite side and/or along the reflector side, for example, is greater, in particular significantly greater, than a thickness of the frequency conversion body measured at least approximately perpendicular hereto.

For example, the thickness of at least the part formed from the frequency-converting medium, for example the entire frequency conversion body, is at least 10 μm, preferably at least 20 μm, for example at least 50 μm.

In some advantageous embodiments, the thickness of at least the part formed from the frequency-converting medium, for example the entire frequency conversion body, is at least 200 μm, in particular at least 500 μm, for example at least 1,000 μm.

In particular, the thickness of at least the part formed from the frequency-converting medium, for example the entire frequency conversion body, is less than or equal to 25 mm, preferably less than or equal to 20 mm, for example less than 15 mm.

In some preferred embodiments, the thickness of at least the part formed from the frequency-converting medium, for example the entire frequency conversion body, is less than or equal to 10 mm, for example less than or equal to 5 mm.

Preferably, the lateral extent of the frequency conversion body, which is measured in particular perpendicular to the direction of the thickness, is greater than or equal to 50 μm, preferably greater than or equal to 100 μm, in particular greater than or equal to 200 μm.

In some advantageous embodiments, the lateral extent of the frequency conversion body is greater than 1 mm, in particular greater than 3 mm, for example greater than 5 mm.

In particular, the lateral extent of the frequency conversion body is greater than a beam cross-section of the radiation field, which can be up to 80 cm, for example, in other embodiments up to 50 cm or up to 30 cm.

An upper limit for the lateral extent of the frequency conversion body is selected in particular so that excessive material consumption is avoided.

For example, the lateral extent of the frequency conversion body is less than or equal to 1 m. In some embodiments, the lateral extent is less than or equal to 70 cm, in particular less than or equal to 40 cm.

In particular, one extent is significantly larger or significantly smaller than another extent if these extents differ by at least a factor of five, preferably by at least a factor of ten, for example by at least a factor of twenty.

It is particularly advantageous if the geometric embodiment of the, in particular thin, frequency conversion body is such that at least approximately one-dimensional heat conduction takes place in it.

In particular, heating of the frequency conversion body caused by parasitic effects, for example, is thus dissipated substantially in a one-dimensional direction when a radiation field is transmitted through it, so that thermally induced inhomogeneous interference in the radiation field is preferably at least reduced by differently oriented temperature gradients.

For example, the embodiment of the frequency conversion body is such that the at least approximately one-dimensional heat conduction, in particular from the part formed from the frequency-converting medium, takes place in the direction of the reflector side.

The heat generated here can preferably be dissipated efficiently via the large-area flat reflector side.

Preferably, the embodiment of the frequency conversion body is such that the at least approximately one-dimensional heat conduction, in particular from the part formed from the frequency-converting medium, takes place in the direction of the side opposite the entry side and/or exit side.

No further details have yet been provided with regard to other elements and/or features of the radiation field provision device.

It is particularly advantageous if the radiation field provision device has at least one cooling body, which is connected to the frequency conversion body to conduct heat in particular, so that heat is dissipated from the frequency conversion body to the cooling body in a favorable manner.

In particular, the at least one cooling body forms a heat sink.

In particular, at least one cooling body is arranged on a side of the frequency conversion body opposite the entry side and/or exit side.

Preferably, at least one cooling body is arranged on a side of the frequency conversion body on which the reflector is formed.

In particular, the reflector is arranged here between the frequency-converting medium and the cooling body.

Advantageously, the cooling body can thus be optimized in terms of heat dissipation and can cool the frequency conversion body in a favorable manner without negatively influencing the radiation field propagating along the optical path.

In particular, the cooling body can be solid.

For example, the cooling body has good thermal conductivity and/or a high specific heat.

It is particularly favorable if the cooling body is connected to the frequency conversion body over a large area, so that effective cooling is realized and the heat is preferably dissipated to the cooling body in substantially one dimension.

For example, the radiation field provision device has a front-side optical body, which lies against one of the sides of the frequency conversion body forming the entry side and/or exit side.

In particular, the front-side optical body is at least approximately transparent for the radiation field components.

Advantageously, the radiation field is coupled into the frequency conversion body and/or out of the frequency conversion body by the front-side optical body.

In particular, this enables a coupling in of the radiation field at a Brewster angle.

In some advantageous embodiments, a coupling in and/or decoupling of the radiation field component propagating within the frequency conversion body at a frequency conversion angle is enabled by means of the front-side optical body and total reflection on the entry side and/or exit side is avoided.

Advantageously, the front-side optical body is also formed as a cooling body.

In particular, at least one cooling body and/or the front-side optical body is connected to the frequency conversion body by adhesion or bonding, for which purpose these preferably have slightly curved surfaces that make contact with one another.

No further information has yet been provided regarding further details of the optical path and the radiation field provision device.

In particular, it is provided that the radiation field provision device comprises a system of optical elements, which in particular define the optical path.

In particular, the optical path comprises a plurality of branches along which a radiation field component or a plurality of radiation field components propagate, and/or a plurality of sub-branches for a respective radiation field component, for example as explained above and below.

In some advantageous embodiments, it is provided that the radiation field components involved in the frequency conversion propagate collinearly along the optical path.

In other preferred embodiments, it is provided that the radiation field components propagate offset and/or obliquely to one another along the optical path, in particular in the frequency conversion body and in particular along the incident and reflected branch.

In particular, the optical path therefore has corresponding sub-branches for the radiation field components, at least along the portions in which the radiation field components propagate offset and/or obliquely to one another.

Preferably, an angle between the respective propagation directions of the radiation field components propagating obliquely to one another is less than or equal to 20°, in particular less than or equal to 10°, for example less than or equal to 5°.

In particular, sub-branches of corresponding radiation field components thus run at an angle to one another which is preferably less than or equal to 20°, in particular less than or equal to 10°, for example less than or equal to 5°.

In particular, these radiation field components propagate in such a way that the radiation field components overlap at least in the region of the frequency-converting medium, in particular along the incident and/or reflected branch, so that the frequency conversion can take place.

In particular, information on the incident branch and/or the reflected branch, in particular on a comparison thereof, for example the symmetrical and/or asymmetrical arrangement thereof and/or angles thereof, is provided above and below, in each case in relation to a corresponding sub-branch of a corresponding radiation field component.

In some advantageous embodiments, it is provided that the optical path is defined such that the radiation field propagates in one direction only along the portion of the optical path running in the frequency conversion body.

In particular, it is therefore provided that when the radiation field propagates along the optical path, it enters the frequency conversion body on the entry side, interacts with the frequency-converting medium and the reflector, for example propagating at least along the incident branch up to the reflector and is reflected at the reflector and propagates further through the frequency conversion body at least along the reflected branch, and exits from the frequency conversion body on the exit side and propagates further along the optical path.

In particular, the radiation field is fed to an application along the optical path after leaving the frequency conversion body.

For example, in some advantageous embodiments, it is provided that the radiation field leaving the frequency conversion body is fed along the optical path to a radiation field amplifier of the radiation field provision device and, in particular, is then fed to an application.

In other preferred embodiments, it is provided that the optical path is defined such that the radiation field propagates in both directions along the portion of the optical path running in the frequency conversion body.

In particular, the radiation field propagates here several times through the frequency conversion body.

In particular, it is therefore provided here that, with respect to a propagation direction, at least a part of the radiation field enters the frequency conversion body on the entry side and interacts with the frequency-converting medium and the reflector, for example, propagating within the frequency conversion body at least along the incident branch up to the reflector and is reflected by the reflector and the radiation field propagates further in the frequency conversion body at least along the reflected branch and exits from the frequency conversion body again at the exit side, and that at least a part of the radiation field propagates in the opposite direction through the frequency conversion body.

For example, an at least partially reflective optical element is arranged further along the optical path after the frequency conversion body and at least partially reflects the radiation field and the reflected part of the radiation field propagates in the opposite direction back to the frequency conversion body and through same.

In particular, an at least partially reflective optical element is arranged here further along the optical path and at least partially reflects the radiation field.

In particular, the frequency conversion body is arranged between two at least partially reflective optical elements.

The radiation field provision device can comprise a very wide range of optical components.

In preferred embodiments, the radiation field provision device comprises a resonator or a plurality of resonators.

In some particularly advantageous embodiments, it is provided that the frequency conversion body is arranged outside at least one resonator, in particular is arranged behind this at least one resonator with respect to a propagation direction of the radiation field.

For example, a radiation field, in particular a laser radiation field, is generated and/or amplified in this at least one resonator, and this radiation field from this at least one resonator is fed to the frequency conversion body along the optical path for frequency conversion.

In particular, this at least one resonator is formed as a laser oscillator.

In some preferred embodiments, it is provided that the frequency conversion body is arranged within at least one resonator.

Preferably, at least one radiation field component involved in the frequency conversion is resonant here in the at least one resonator in which the frequency conversion body is arranged.

In some advantageous embodiments, the at least one resonator in which the frequency conversion body is arranged is resonant for at least a plurality of radiation field components involved in the frequency conversion.

In some advantageous embodiments, it is provided that the radiation field provision device comprises a plurality of resonators, each of which is resonant for at least one radiation field component involved in the frequency conversion, and these plurality of resonators are configured and arranged such that the at least one radiation field component resonant therein propagates through the frequency conversion body for frequency conversion.

In some advantageous embodiments, at least one resonator, in particular a resonator in which the frequency conversion body is arranged, has no laser-active medium.

This at least one resonator is used in particular to increase at least one radiation field component involved in the frequency conversion, for example by increasing the intensity of the radiation field component and/or by passing this at least one radiation field component through the frequency conversion body more often, which preferably results in an increase in the frequency conversion rate.

In some preferred embodiments, it is provided that at least one resonator comprises a laser-active medium for amplifying at least one radiation field component propagating in the resonator and involved in the frequency conversion.

For example, in some embodiments, at least one resonator in which the frequency conversion body is arranged has a laser-active medium.

In particular, in some embodiments it is provided that the at least one resonator, outside of which the frequency conversion body is arranged, comprises a laser-active medium.

In particular, in some embodiments, the radiation field provision device comprises an amplifier unit.

In particular, the amplifier unit comprises a laser-active medium through which the optical path passes.

Preferably, the amplifier unit comprises a pump device for supplying pump energy to the laser-active medium.

For example, the pump device is configured to pump the laser-active medium electrically or optically.

For example, the pump device comprises a radiation source for providing a pump radiation field, which introduces the pump energy into the laser-active medium.

In the foregoing and in the following, the wording “at least approximately” in conjunction with a feature is to be understood in particular as including technically induced and/or technically relevant deviations from the feature. For example, deviations of up to 5%, preferably up to ±2%, in particular up to ±0.5%, for example up to ±0.1%, from a value specified at least approximately are included in this specification. For example, for directions that are specified at least approximately, deviations from the specified direction of up to ±2°, preferably up to ±1°, in particular up to ±0.1°, for example up to ±0.05°, are included in the specification.

Features in conjunction with which these are mentioned as being particularly provided, preferred, favored or the like are optional features which are not absolutely necessary for the invention, but which contain, for example, advantageous further developments.

The above description of solutions according to the invention thus comprises in particular the various combinations of features defined by the following numbered embodiments:
1. A radiation field provision device, in which in particular an optical path (150) for a radiation field is defined, comprising a frequency conversion body (110), wherein the frequency conversion body (110) is partially formed from a frequency-converting medium and a reflector (120).
2. A radiation field provision device in accordance with embodiment 1, wherein, in the case of a radiation field propagating along the optical path (150), a radiation field component in the frequency-converting medium of the frequency conversion body (110) which is involved in a frequency conversion and is comprised by the radiation field, before it impinges on the frequency conversion body (110), in particular directly, is at least partially converted by the frequency conversion into a radiation field component with a different frequency.
3. A radiation field provision device in accordance with the preceding embodiments, wherein, in the case of a radiation field propagating along the optical path (150), a frequency conversion takes place along at least one branch (152, 154) of a portion of the optical path (150) running in the frequency conversion body (110).
4. A radiation field provision device in accordance with the preceding embodiments, wherein the portion of the optical path (150) running in the frequency conversion body (110) comprises an incident branch (152) which transitions in the frequency conversion body (110) at the reflector (120) into a reflected branch (154) of the portion of the optical path (150) running in the frequency conversion body (110).
5. A radiation field provision device in accordance with the preceding embodiments, wherein a frequency conversion takes place at least along the reflected branch (154).
6. A radiation field provision device in accordance with the preceding embodiments, wherein a frequency conversion takes place at least along the incident branch (152).
7. A radiation field provision device in accordance with the preceding embodiments, wherein along at least one branch (152, 154) of the portion of the optical path (150) running in the frequency conversion body, in particular along the incident branch (152), no frequency conversion takes place in the case of a radiation field propagating along the optical path (150).
8. A radiation field provision device in accordance with the preceding embodiments, wherein the frequency-converting medium of the frequency conversion body (110) has at least one marked axis (142), wherein a frequency conversion takes place in the case of a radiation field of which the radiation field components involved in a frequency conversion propagate at a frequency conversion angle, in particular lying in a frequency conversion angle band, to the marked axis.
9. A radiation field provision device in accordance with embodiment 8, insofar as it is referred back to one of embodiments 1 to 6, wherein the incident branch (152) and the reflected branch (154) run symmetrically to the marked axis of the frequency-converting medium of the frequency conversion body (110).
10. A radiation field provision device in accordance with embodiment 8, wherein the incident branch (152) and the reflected branch (154) run asymmetrically with respect to the marked axis (142) of the frequency-converting medium of the frequency conversion body (110).
11. A radiation field provision device in accordance with the preceding embodiments, wherein a radiation field propagating along the optical path (150) is reflected by the reflector (120) after impinging on the frequency conversion body (110) and before leaving the frequency conversion body (110).
12. A radiation field provision device in accordance with the preceding embodiments, wherein the reflector (120) is at least partially formed and/or arranged on an opposite side of the frequency conversion body (110) the opposite side being opposite to an entry side (126) and/or an exit side (128), wherein the optical path (150) enters the frequency conversion body (110) at the entry side (126) and the optical path (150) exits the frequency conversion body (110) at the exit side (128).
13. A radiation field provision device in accordance with the preceding embodiments, wherein the reflector (120) is at least partially formed on the side of the frequency conversion body (110) forming the entry side (126) and/or the exit side (128), wherein the optical path (150) enters the frequency conversion body (110) at the entry side (126) and the optical path (150) exits the frequency conversion body (110) at the exit side (128).
14. A radiation field provision device in accordance with the preceding embodiments, wherein the reflector (120) is at least partially formed and/or arranged on a reflector side (112) of the part (115) of the frequency conversion body (110) formed from the frequency-converting medium.
15. A radiation field provision device in accordance with the preceding embodiments, wherein the reflector (120) is attached, for example bonded, to the frequency-converting medium.
16. A radiation field provision device in accordance with the preceding embodiments, wherein the reflector (120) is formed at least partially from the frequency-converting medium.
17. A radiation field provision device in accordance with the preceding embodiments, wherein the reflector (120) comprises an at least substantially flat reflection surface (146), wherein in particular a radiation field propagating along the optical path (150) is reflected at least on a macroscopic scale relative to the reflection surface (146).
18. A radiation field provision device in accordance with the preceding embodiments, wherein the reflection surface (146) of the reflector (120) extends at least approximately perpendicular to the marked axis (142) of the frequency-converting medium of the frequency conversion body (110).
19. A radiation field provision device in accordance with embodiments 1 to 17, wherein the reflection surface (146) of the reflector (120) runs obliquely to the marked axis (142) of the frequency-converting medium of the frequency conversion body (110).
20. A radiation field provision device in accordance with the preceding embodiments, wherein the reflector (120) provides a reflected radiation field in which the radiation field components (182, 184, 186) involved in the frequency conversion fulfil conditions adapted for the frequency conversion, in particular have at least one phase relationship to one another adapted for the frequency conversion.
21. A radiation field provision device in accordance with the preceding embodiments, wherein the reflector (120) is formed in such a way that phase relationships between at least the radiation field components (182, 184, 186) involved in the frequency conversion remain at least substantially unchanged by the reflector (120).
22. A radiation field provision device in accordance with the preceding embodiments, wherein the reflector (120) comprises multiple layers.
23. A radiation field provision device in accordance with the preceding embodiments, wherein the reflector (120) has at least one layer assembly (162, 164, 166) which reflects at least one radiation field component (182, 184, 186) involved in the frequency conversion, in particular has a layer assembly (162, 164, 166) reflecting this radiation field component (182, 184, 186) for each incident radiation field component (182, 184, 186) involved in the frequency conversion.
24. A radiation field provision device in accordance with the preceding embodiments, wherein the reflector (120) comprises at least one phase matching layer (176, 178) for phase matching at least one radiation field component (182, 184, 186) involved in the frequency conversion.
25. A radiation field provision device in accordance with the preceding embodiments, wherein the reflector (120) comprises an optical grating.
26. A radiation field provision device in accordance with the preceding embodiments, wherein a part (115) of the frequency conversion body (110) comprising the frequency-converting medium has, on a reflector side (120), a flat intermediate surface, on which in particular the reflector (120) is arranged and/or formed directly.
27. A radiation field provision device in accordance with the preceding embodiments, wherein a surface of the frequency conversion body (110) at an entry side (126), at which the optical path (130) enters the frequency conversion body (110), and/or a surface of the frequency conversion body (110) at an exit side (128), at which the optical path (150) exits the frequency conversion body, runs at least substantially parallel to the intermediate surface of the part (115) comprising the frequency-converting medium on its reflector side (112).
28. A radiation field provision device in accordance with the preceding embodiments 1 to 26, wherein a surface of the frequency conversion body (110) at an entry side (126), at which the optical path enters the frequency conversion body (110), and/or a surface of the frequency conversion body at an exit side (128), at which the optical path exits the frequency conversion body (110), runs obliquely to the intermediate surface of the part (115) comprising the frequency-converting medium, on the reflector side (112) thereof, wherein the surface of the entry side (126) and/or exit side (128) is in particular at an angle which is equal to or less than 5°, in particular equal to or less than 2°, and/or at an angle which is equal to or greater than 0.1°, in particular equal to or greater than 0.5°.
29. A radiation field provision device in accordance with the preceding embodiments, wherein the surface of the frequency conversion body (110) at its entry side (126), at which the optical path (150) enters the frequency conversion body (110), and the surface of the frequency conversion body (110) at its exit side (128), at which the optical path (150) exits the frequency conversion body, run obliquely to one another.
30. A radiation field provision device in accordance with the preceding embodiments, wherein the frequency conversion body (110) has a coating on the surface at its entry side (126) and/or on the surface at its exit side (128).
31. A radiation field provision device in accordance with the preceding embodiments, wherein the frequency conversion body (110) is a thin body.
32. A radiation field provision device in accordance with the preceding embodiments, wherein the geometric embodiment of the frequency conversion body (110) is such that an at least approximately one-dimensional heat conduction, in particular in the direction of the side opposite the entry side (126) and/or exit side (128), takes place in it.
33. A radiation field provision device in accordance with the preceding embodiments, wherein it has at least one cooling body (191, 192).
34. A radiation field provision device in accordance with embodiment 33, wherein at least one cooling body (191) is arranged on a side of the frequency conversion body (110) opposite the entry side (126) and/or exit side (128).
35. A radiation field provision device in accordance with embodiment 33 or 34, wherein at least one cooling body (191) is arranged on a side of the frequency conversion body (110) on which the reflector (120) is formed.
36. A radiation field provision device in accordance with one of the preceding embodiments, wherein a front-side optical body (192) is arranged on a side of the frequency conversion body (110) forming the entry side (126) and/or exit side (128), wherein in particular the radiation field is coupled into the frequency conversion body (110) through the front-side optical body (192) and/or is coupled out of the frequency conversion body (110), wherein in particular the front-side optical body (192) is formed as a cooling body.
37. A radiation field provision device in accordance with the preceding embodiments, wherein it comprises a system of optical elements which in particular define the optical path.
38. A radiation field provision device in accordance with the preceding embodiments, wherein it comprises a resonator or a plurality of resonators.
39. A radiation field provision device in accordance with embodiment 38, wherein the frequency conversion body (110) is arranged outside at least one resonator.
40. A radiation field provision device in accordance with embodiment 38 or 39, wherein the frequency conversion body (110) is arranged within at least one resonator.

Explanations of preferred features and advantages of the invention are the subject of the following detailed description of the exemplary embodiments shown in the drawings.

### BRIEF DESCRIPTION OF THE DRAWINGS

Shown in the drawings are:

FIG. 1 a schematic sectional view of a frequency conversion body of a first exemplary embodiment of a radiation field provision device;

FIG. 2 four schematic representations of various non-linear processes that cause a frequency conversion;

FIG. 3 an illustration of an exemplary embodiment of a reflector comprising a plurality of layers;

FIG. 4 three different exemplary embodiments of a reflector comprising an optical grating;

FIG. 5 an illustration similar to FIG. 1 of a further exemplary embodiment, in which one exit side of the frequency conversion body is beveled;

FIG. 6 an illustration similar to FIG. 5 of a variant of the exemplary embodiment, in which surfaces of an exit side and an entry side of the frequency conversion body run obliquely to an opposite side;

FIG. 7 an illustration of a further exemplary embodiment in which a frequency conversion body has an optical grating on a side forming an entry side and an exit side;

FIG. 8 a similar representation as in FIG. 1 of a further exemplary embodiment in which an incident branch and a reflected branch of an optical path run asymmetrically with respect to a marked axis of a frequency-converting medium of the frequency conversion body;

FIG. 9 an illustration of an exemplary embodiment of a radiation field provision device which comprises at least one radiation field source for radiation field components for a frequency conversion;

FIG. 10 an illustration of an exemplary embodiment of a radiation field provision device which has a frequency conversion body outside a resonator, and

FIG. 11 an illustration of an exemplary embodiment of a radiation field provision device comprising a resonator and a frequency conversion body within the resonator.

### DETAILED DESCRIPTION OF THE INVENTION

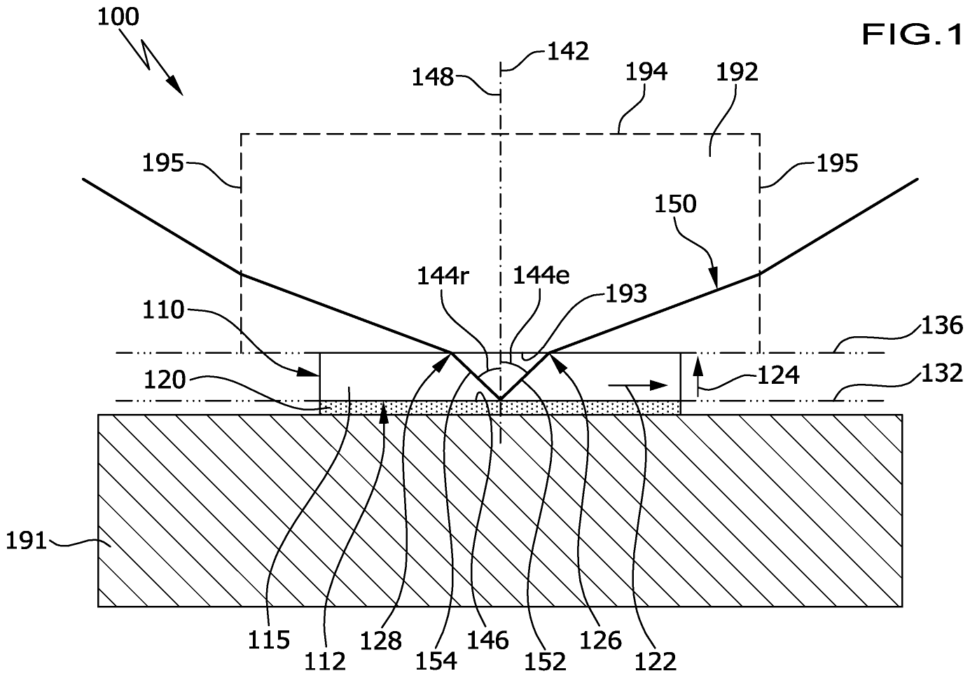

In a first exemplary embodiment of a radiation field provision device shown by way of example in FIG. 1, the device comprises a frequency conversion body designated in its entirety as 110, which is partially formed from a frequency-converting medium and comprises a reflector 120.

Preferably, the reflector 120 is arranged on a reflector side 112 of a part 115 of the frequency conversion body 110 formed from the frequency-converting medium, in particular directly on this part 115, in particular attached, for example bonded thereto, so that the part 115 forming the frequency-converting medium and the reflector 120 form the frequency conversion body 110.

The frequency-converting medium is a non-linear optical medium in which a radiation field is subject to non-linear processes that cause a frequency conversion when certain requirements are met, so that at least one component of the radiation field is converted into another component with a different frequency.

In particular, second-order non-linear processes are utilized for frequency conversion, although higher-order processes, such as third-order processes, are also used in some variants.

For frequency conversion, it is particularly necessary that corresponding non-linear processes take place on an atomic scale and that constructive interference conditions are present so that at least one radiation field component is at least partially converted into another component with a different frequency on a macroscopic scale. The conditions required for frequency conversion are discussed in greater detail below.

In the following, the conversion of radiation field components during frequency conversion and the necessary conditions for this are considered on a macroscopic scale.

In particular, at least three radiation field components with frequencies ω₁, ω₂ and ω₃ are involved in the frequency conversion, wherein the conversion of these radiation field components takes place differently depending on the variant of the exemplary embodiment.

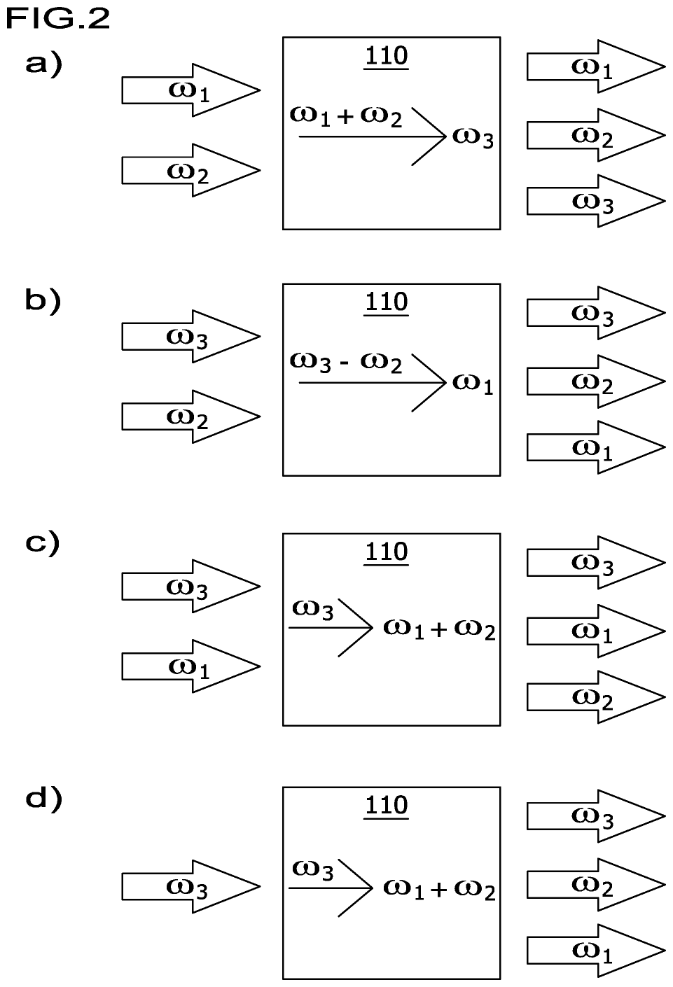

In some variants of the exemplary embodiment, the frequency conversion comprises a sum frequency generation. In this case, a radiation field with at least two radiation field components, which have frequencies ω₁ and ω₂, is irradiated and a third radiation field component with a frequency ω₃=ω₁+ω₂ is at least partially generated from these two components by the non-linear processes, as shown schematically in FIG. 2 under a). In particular, the frequencies of the first and second radiation field components are different, so that ω₁≠ω₂ applies. In the case of frequency doubling, which is a special case of sum frequency generation, the frequencies of the first and second radiation field components are the same, so that ω₁=ω₂ applies.

This means that a third radiation field component is generated, which has a higher frequency ω₃ than the two irradiated radiation field components.

In some variants of the exemplary embodiment, the frequency conversion comprises a difference frequency generation. In this case, a radiation field component, which is also called the idler component, is generated with a frequency ω₁ from two irradiated radiation field components, which are also called the pump component and the signal component and have frequencies ω₃ and ω₂, wherein the frequency of the generated radiation field component, i.e., the idler component, is the difference between the frequencies of the irradiated radiation field components, i.e., the frequencies of the pump component and the signal components, so that the following applies to the frequencies: ω₁=ω₃−ω₂, as shown schematically under b) in FIG. 2. Typically, ω₂≠ω₁ applies here. This means that a radiation field component, for example a so-called idler component, of the radiation field is generated which has a lower frequency than at least one component, for example the pump component, of the irradiated radiation field.

In some variants of the exemplary embodiment, the frequency conversion comprises a parametric amplification shown schematically in FIG. 2 under c). In this case, an irradiated radiation field component, for example a so-called signal component, is amplified with a frequency ω₂ by irradiating a pump component with a frequency ω₃, which at least partially amplifies the one radiation field component due to the non-linear processes, for example the signal component, and is partially converted into a further radiation field component, for example a so-called idler component, with a frequency @1, wherein for the frequencies it applies in particular that ω₃=ω₁+ω₂, and for example ω₂≠ω₁.

In particular, the power of the irradiated signal component is significantly lower with parametric amplification than with differential frequency generation.

In some variants of the exemplary embodiment, the frequency conversion comprises a parametric generation, in which two radiation field components, for example a so-called idler component and a so-called signal component, of the radiation field with frequencies ω₁ and ω₂ are generated from an irradiated radiation field component, in particular a so-called pump component, with a frequency ω₃, wherein ω₃=ω₁+ω₂ applies for the frequencies, as shown schematically and by way of example under d) in FIG. 2.

For example, parametric generation is also used to generate single or entangled photons.

In particular, the non-linear processes do not completely convert the irradiated radiation field components, so that converted radiation field components as well as residual components of the irradiated radiation field components are present in the radiation field leaving the frequency conversion body 110.

For example, the conditions required for frequency conversion include that the irradiated radiation field components have a sufficiently high intensity and/or that the radiation field components propagate through the mostly anisotropic frequency-converting medium in a direction that enables frequency conversion and/or that the phases of the radiation field components involved in the frequency conversion have a suitable relationship to one another (so-called phase matching).

During frequency conversion, the at least one frequency-converted radiation field component is generated with a specific phase relationship to the at least one starting component.

Frequency conversion therefore induces a phase relationship between the radiation field components involved.

A favorable and matched phase relationship between the radiation field components is therefore in particular the induced phase relationship.

For example, a phase shift of Φ₃−Φ₂−ψ₁=±π/2 modulo (2π) between the phases of the radiation field components involved in the frequency conversion, in particular the phases of the pump, signal and idler components, is induced during the frequency conversion, wherein, in particular, Φ₃ is the phase of the radiation field component with the frequency ω₃ and Φ₂ is the phase of the radiation field component with the frequency ω₂ and Φ₁ is the phase of the radiation field component with the frequency ω₁ and, in particular, Φ₃ is greater than ω₂ and ω₂ is greater than or equal to ω₁.

Preferably, the frequency conversion body 110 is a thin body, for example a thin disc, wherein an extent of the frequency conversion body 110 in a lateral direction 122, which runs at least approximately along a side forming an entry side 126 and an exit side 128 for a radiation field and, for example, along the reflector side 112, is greater, for example substantially greater, than an extent of the frequency conversion body 110 from the side forming the entry side 126 and the exit side 128 in a direction of extent 124 running at least approximately perpendicular to the lateral direction 122 to an opposite side.

In particular, an intermediate surface on the reflector side 112 between the frequency-converting medium and the reflector is a flat surface or a surface that is at most slightly curved, in particular a surface with a radius of curvature greater than 0.5 m. The surfaces on the side forming the entry side 126 and the exit side 128 are preferably at least approximately flat surfaces.

For example, the intermediate surface on the reflector side 112 and the surface on the side forming the entry side 126 and exit side 128 can be at least approximately described by corresponding geometric planes 132 and 136, respectively, wherein these geometric planes 132 and 136 are at least approximately parallel to one another and the direction of extent 124 is at least approximately perpendicular to these planes 132, 136.

The, in particular anisotropic, frequency-converting medium of the frequency conversion body 110 has a marked axis 142, wherein a radiation field penetrating the medium at a frequency conversion angle to this marked axis 142 with at least one radiation field component to be converted is subject to the non-linear processes and the component thereof to be converted is at least partially converted into at least one component with a different frequency.

In particular, the conditions for frequency conversion are fulfilled for several angles in a frequency conversion angle band, so that there are several, in particular similar, frequency conversion angles.

Preferably, the frequency conversion body 110 comprises an anisotropic crystal forming the frequency-converting medium, and in particular the marked axis 142 is a crystal axis of the crystal.

In this variant of the exemplary embodiment, the marked axis 142 runs at least approximately perpendicular to the geometric plane 132 of the reflector side 112, so that the reflector 120 arranged on the reflector side 112 also extends at least approximately perpendicular to the marked axis 142 and, in particular, a reflector surface 146 of the reflector 120 extends at least approximately perpendicular to the marked axis 142.

In the unit and in particular in the radiation field provision device, an optical path denoted 150 is defined for a radiation field, in particular by the reflector and for example by further optical elements, and enters the frequency conversion body 110 on the entry side 126 and extends along an incident branch 152 in the frequency conversion body 110 up to the reflector 120 and at this, in particular by reflection relative to the reflector surface 146, into a reflected branch 154, which runs in the frequency conversion body 110, and the optical path 150 lastly runs out again from the frequency conversion body 110 on the exit side 128.

Here, the branch 152 incident on the reflector 120 runs from the entry side 126 to the reflector 120 through the frequency-converting medium and the reflected branch runs from the reflector 120 to the exit side 128 through the frequency-converting medium.

The reflector surface 146 preferably runs at least approximately parallel to the geometric plane 132 of the reflector side 112, and the incident branch 152 and the reflected branch 154 run symmetrically with respect to the normal 148 of the plane 132.

In this case, the incident branch 152 runs at an angle 144e to the marked axis 142 and the reflected branch 154 runs at an angle 144r to the marked axis 142, wherein, since in this exemplary embodiment the marked axis 142 runs at least substantially perpendicular to the reflector surface, the angles 144e and 144r are at least approximately equal.

In particular, it is provided that the two angles 144e and 144r of the incident and reflected branch to the marked axis 142 correspond to the frequency conversion angle, so that along both branches 152, 154 a corresponding radiation field is subject to the frequency-converting processes.

In some variants of the exemplary embodiment, it is provided that the incident radiation field components with different frequencies required for the frequency conversion, for example the signal component and the idler component or the pump component and the signal component, are incident on the reflector 120 coaxially along the same incident branch 152 and thus run at the same angles to the normal 148 of the plane 132. Due to the conservation of momentum, the component of the radiation field arising during frequency conversion also propagates along the same branches 152, 154 after arising in the frequency conversion body, through the latter.

In other variants of the exemplary embodiment, the incident radiation field components required for the frequency conversion, for example the signal component and/or the idler component and/or the pump component, are incident on the reflector 120 at different angles to the normal 148 of the reflector side 112, so that their corresponding angle of incidence 144e to the marked axis fulfils the conditions for the non-linear processes and is therefore also a frequency conversion angle in each case. The frequency-converted component resulting from the non-linear processes then runs at a further, different angle to the normal of the reflector side, which results from the conservation of momentum. Thus, in these variants, the optical path 150 comprises a corresponding incident branch 152 and reflected branch 154 for each radiation field component involved in the frequency conversion in the frequency conversion body 110, which may be different.

In particular, in this exemplary embodiment it is provided that the reflector 120 provides at least the reflected radiation field components involved in the non-linear processes with a phase relationship adapted and required for the frequency conversion, so that after reflection these radiation field components have the required and an adapted phase relationship to one another.

For example, the reflector 120 is formed such that it at least approximately maintains a phase relationship between at least the radiation field components involved in the non-linear processes that impinge on the reflector 120 along the incident branch 152.

Preferably, the reflector is formed in such a way that it at least partially compensates for deviations in the phase relationship between the incident radiation field components involved in the non-linear processes, which can occur, for example, due to disturbances in the propagation of the radiation field components.

This means that the corresponding radiation field components also have a matched and required phase relationship to one another in the reflected radiation field, so that the desired frequency conversion can take place efficiently along the reflected branch and, in particular, the radiation field components interfere constructively.

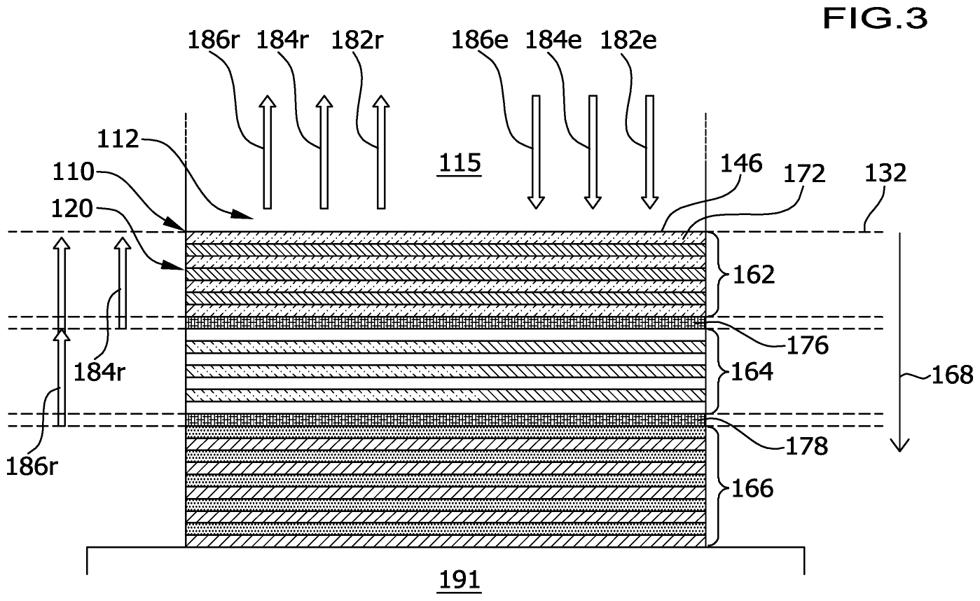

In one variant of the exemplary embodiment, the reflector 120 is formed as a dielectric mirror from a plurality of dielectric layers, as shown by way of example in FIG. 3.

In particular, the reflector 120 comprises three layer assemblies 162, 164 and 166, which are each formed from a plurality of dielectric layers with alternating high and low refractive indices. In each case one of these layer assemblies 162, 164, 166 is formed as a reflector for one of the radiation field components involved in the non-linear processes, for example the layer assembly 162 is configured to be reflective for the pump component, the layer assembly 164 is configured to be reflective for the signal component, and the layer assembly 166 is configured to be reflective for the idler component.

For example, the layers of each of the layer assemblies 162, 164, 166 have a thickness such that an optical path length through them corresponds at least approximately to a quarter of the wavelength of the radiation field component to be reflected.

The layer assemblies 162, 164, 166 are arranged one behind the other in relation to the direction of penetration 168, wherein one of the layer assemblies, for example the layer assembly 162, is arranged closest to the frequency conversion body 110 and in particular an uppermost layer 172 is arranged on the reflector side 112 of the part 115 formed from the frequency-converting medium.

For example, the layer assembly 164 is arranged next in the direction of penetration 168, followed by the layer assembly 166.

Preferably, a respective phase matching layer is also arranged between every two of the layer assemblies, for example a phase matching layer 176 between the layer assemblies 162 and 164 and a phase matching layer 178 between the layer assemblies 164 and 166.

Here, the phase matching layers 176 ,178 are configured, in particular with regard to their material with a corresponding calculation index and their thickness, in such a way that a phase of a corresponding component of the radiation field is shifted relative to the phases of the other components relevant for the non-linear processes, so that the respective radiation field components are provided by the reflector 120 with a phase relationship relative to one another that is adapted to the frequency conversion.

For example, a radiation field component 182e, for example the pump component of the radiation field, first falls along the incident branch 152 onto the first layer assembly 162, which is configured to reflect this radiation field component 182, so that the radiation field component propagates through this layer assembly 162 as a reflected component 182r along the reflected branch 154.

A further radiation field component 184e, for example the signal component, of the incident radiation field propagates along the incident branch 152 through the frequency conversion body 110 and initially impinges on the first layer assembly 162, through which this component 184e undergoes a phase shift, and in particular also through the phase matching layer 176 before this component 184e impinges on the layer assembly 164, which is configured to reflect precisely this component 184 and reflects it, so that a reflected component 184r propagates through the phase matching layer 176 and the first layer assembly 162 and lastly propagates further along the reflected branch 154 through the frequency conversion body 110.

The formation of the first layer assembly 162 is already defined by the fact that it has to reflect the component 182, so that the component 184 undergoes a predetermined phase shift by passing twice through the first layer assembly 162, but this phase shift is compensated for by the phase matching layer 176, which is also penetrated twice by the component 184 and is formed in such a way that the phase shift of the second component 184 relative to the first component 182 has the adapted phase relationship for the non-linear processes and the efficient frequency conversion.

In addition, a third radiation field component 186e involved in the non-linear processes, for example the idler component, impinges on the reflector 120 and first penetrates the first layer assembly 162 and, for example, the first phase matching layer 176 as well as the second layer assembly 164 and, for example, the second phase matching layer 178 before this component 186 impinges on the third layer assembly 166, which is configured to reflect precisely this component 186 and reflects this component, so that a reflected component 186r in turn penetrates the second phase matching layer 178, the second layer assembly 164, for example the first phase matching layer 176 and the first layer assembly 162 and propagates further on the reflected branch 154 through the frequency conversion body 110.

Here, the formations of the layer assemblies 162 and 164 for reflection of the respective components 182 and 184 are already predetermined and the formation of the phase matching layer 176 for phase matching of the component 184 is predefined, so that the component 186 undergoes a predetermined phase shift due to the double propagation through these layer assemblies 162, 164 and the phase matching layer 176, wherein the phase matching layer 178 is now configured to compensate for the predetermined phase shift induced by the other layers, so that the reflected component 186r leaving the reflector 120 has the phase relationship to the other two components 182 and 184 that is adapted for the non-linear processes and for efficient frequency conversion.

Preferably, a cooling system is also provided for the unit, wherein the cooling system comprises at least one cooling body 191 which is arranged on the rear side of the frequency conversion body 110, so that the reflector 120 is arranged between the frequency-converting medium and the cooling body 191.

For example, the frequency conversion body 110 with the reflector 120 is arranged directly on the cooling body 191, in particular the third layer assembly 166 is arranged on the cooling body 191.

Preferably, the cooling body 191 is a solid body, in particular a substantially larger body compared to the frequency conversion body 110.

It is preferable if a lateral extent of the cooling body 191 is greater than the lateral extent of the frequency conversion body 110.

It is particularly favorable if the cooling body is made of a material with particularly good thermal conductivity.

For example, a front-side optical cooling body 192, for example a further cooling body, is arranged on the side of the frequency conversion body 110 forming the entry side 126 and the exit side 128. Since this front-side optical body 192 is penetrated by the radiation field before and after said field passes through the frequency conversion body 110, this front-side optical body 192 is formed from a material which is at least approximately transparent to the radiation field and which preferably influences the propagation of the radiation field to the smallest possible extent.

One side 193 of the front-side optical body 192 abuts the frequency conversion body 110, in particular the side thereof forming the entry side 126 and the exit side 128, and lateral sides 195 of the front-side optical body extend away from the abutting side 193.

For example, the front-side optical body 292 has a side 194 opposite the abutting side 193, wherein the abutting side 193 and the opposite side 194 are connected to one another by lateral sides 195. In particular, the front-side optical body 192 is cuboidal or has the shape of a truncated pyramid or is trapezoidal in cross-section running from the abutting side 193 to the opposite side 194.

In other variants, at least two sides of the lateral sides 195 lying opposite one another run towards one another and meet at an edge opposite the abutting side 193. In particular, the front-side body 192 is triangular prism-shaped.

In favorable variants of the exemplary embodiment, a portion of the optical path 150 runs through one of the lateral sides 195 and from there to the side 193 abutting the frequency conversion body 110, where the optical path 150 further enters the frequency conversion body 110 and has the portion with the incident branch 152.

Accordingly, the optical path 150 has a further portion from the side 193 abutting the frequency conversion body 110 in the front-side optical body 192, which runs to a further lateral side 195, wherein this portion in the front-side optical body 192 adjoins the portion of the optical path in the frequency conversion body 110 having the reflected branch 154 in the course of the optical path 150.

For example, this makes it easier or even possible in the first place to couple in the radiation field at large angles 144 to the marked axis 142.

For example, in the arrangement with the further optical body 192, angles 144 of the branches 152, 154 to the marked axis 142 can also be realized, at which total reflection would occur in a transition from the frequency conversion body 110 to air.

In other variants of the exemplary embodiment, it is provided that the optical path 150 enters at the side 194 opposite the frequency conversion body 110 with one portion and exits with a further portion.

Preferably, the front-side optical body 192 is also formed as a further cooling body, thereby improving cooling of the frequency conversion body.

In particular, a mode of operation of the radiation field provision device is thus as described below.

The radiation field enters the frequency conversion body 110 at the entry side 126 and is subject to non-linear processes at least on a branch 152 of the optical path 150, since the branch 152 runs through the frequency-converting medium of the frequency conversion body 110 at an angle 144, which corresponds to a frequency conversion angle, to the marked axis 142, and thus at least one further component with a different frequency arises along the branch 152 from at least one component of the radiation field due to the non-linear processes.

The radiation field with the various components impinges on the reflector 120, which in particular runs at least approximately perpendicularly with a reflector surface 146 to the marked axis 142, so that the reflected radiation field also propagates along the reflected branch 154 at the angle 144 to the marked axis 142 corresponding to the frequency conversion angle through the frequency-converting medium of the frequency conversion body 110 and therefore a frequency conversion of at least one component into at least one further component of the radiation field also takes place on the reflected branch 154.

The frequency conversion is particularly efficient because the reflector 120 is formed such that the phase relationship between the various components of the radiation field, which is adapted for the non-linear processes and induced by these processes, is maintained and is thus also present in the reflected radiation field on the reflected branch 154, and thus the frequency conversion takes place at least approximately only in the desired direction from at least one radiation field component into at least one other radiation field component and an oscillation of energy back and forth between the various radiation field components is at least approximately suppressed.

The radiation field lastly emerges from the frequency conversion body 110 on the exit side 128 and has at least one frequency-converted component for further use inside or outside the radiation field provision device.

The frequency conversion body 110 is preferably efficiently cooled by the cooling body 191, which is arranged along at least approximately the entire lateral extent of said body, wherein the radiation field does not have to propagate through the cooling body 191 as the reflector 120 is arranged between the frequency-converting medium and the cooling body 191. In this way, quality losses in the radiation field associated with penetration of the cooling body 191 are avoided.

Furthermore, the frequency conversion body 110 is in particular a thin body, the extent of which is greater in the lateral direction 122 than in the direction of extent 124, so that preferably the heat dissipation in the frequency conversion body 110 is at least approximately one-dimensional transverse, in particular at least approximately perpendicular, to the lateral direction 122 from the frequency-converting medium through the reflector 120, for example to the cooling body 191.

Advantageously, one direction of a temperature gradient within the frequency conversion body 110 is oriented at least approximately in the same direction, and in particular at least approximately perpendicular to the lateral direction 122. The substantially homogeneous alignment of the temperature gradient advantageously at least reduces or even largely avoids locally different temperature-induced disturbances, for example thermally induced lens effects, in the radiation field.

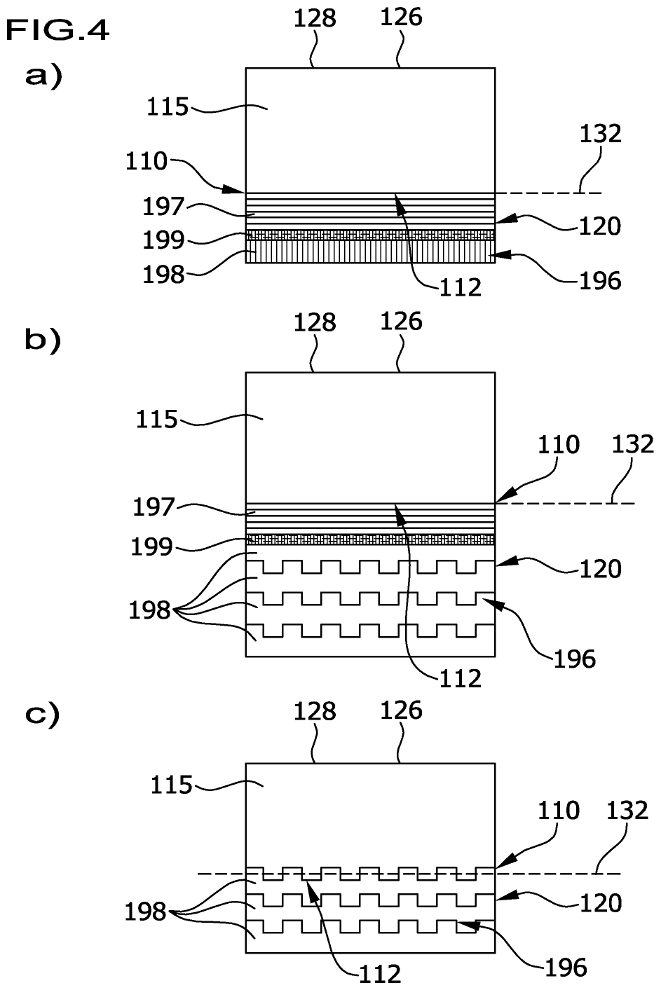

In variants of the exemplary embodiment, which are shown by way of example in FIG. 4 , the reflector 120 of the frequency conversion body 110 has a grating structure 196.

For example, the reflector 120 comprises a coating applied to the reflector side 112 of the part 115 formed from the frequency-converting medium, which coating is reflective for at least one or at least some of the radiation field components involved in the frequency conversion.

In particular, the coating 197 extends at least approximately parallel to and/or in the geometric plane of the reflector side 132.

Preferably, the coating 197 comprises a plurality of layers, which in particular alternately have a high and a low refractive index.

For example, the coating 197 comprises several assemblies of layers, wherein each layer assembly is reflective for a particular radiation field component.

For example, the resonator 120 has a further layer 198, which forms the grating structure 196.

This layer 198 comprises, for example, portions with an alternating refractive index, wherein these portions extend side by side in the layer 198.

In particular, a direction of extent of these portions runs parallel to the geometric plane 132 and the portions are arranged next to one another in a direction that also runs relative to the geometric plane 132 and is at least approximately perpendicular to the direction of extent.

In particular, the grating structure 196 in the layer 198 is formed in such a way that it forms a waveguide for at least one radiation field component.

In the variant shown in FIG. 4a, the layer 198 comprising the grating structure 196 is arranged on a side of an at least partially reflective coating 197 facing away from the frequency-converting medium and, in particular, is arranged on a side of the frequency conversion body 110 that is opposite the side forming the entry side 126 and exit side 128.

In particular, a field component, transmitted through the coating 197, of the incident radiation field components, in particular along the incident branch 152, passes through the grating structure 196, wherein preferably at least one waveguide mode is excited and this resonant mode is reflected back.

In some variations, it is provided that the reflective coating 197 is at least partially reflective for all radiation field components involved in a frequency conversion and the grating structure 196 is formed in such a way that the reflected radiation field components obtain the phase relationship to one another adapted for the frequency conversion by their excited waveguide mode.

For example, a buffer layer 199 is also provided between the coating 197 and the layer 198 comprising the grating structure 196, so that the waveguide mode in the grating structure 196 is substantially excited separately from the modes in the coating 197.

Preferably, the buffer layer is for this purpose made of a material with a low refractive index and, in particular, has a thickness such that the optical path length through this buffer layer corresponds at least approximately to half or a whole wavelength of the radiation field component to be excited.

In a further variation of the reflector with a grating structure 196, which is shown as an example in FIG. 4b, the reflector 120 again has a reflective coating 197, which in particular is applied directly to the frequency-converting medium on the reflector side 120.

In this variation, the grating structure 196 is formed of a plurality of layers 198, wherein these plurality of layers 198 extend at least substantially and at least approximately parallel to the geometric plane 132 of the reflector side 120.

In particular, these multiple layers 198 have alternating high and low refractive indices.

The respective layers have raised and recessed areas in a direction running at least approximately perpendicular to the geometric plane 132, wherein in each case a raised area of one layer engages in a recessed area of the next-adjacent layer to fill the volume.

The grating structure 196 is formed by these raised and recessed areas, which are arranged periodically in particular.

In some variations, it is again provided that the coating 197 at least partially reflects all radiation field components involved in the frequency conversion and a field component transmitting through the coating 197 penetrates the grating structure 196 and the phase matching adapted for the frequency conversion is effected by excitation of the waveguide mode in the reflected radiation field components.

In other variations, however, it is provided that the coating 197 is configured to reflect at least one or some of the radiation field components involved in the frequency conversion and that the grating structure both reflects the remaining radiation field components involved in the frequency conversion and also effects the phase matching by exciting the waveguide mode.

A buffer layer 199 is also provided in this variant of the exemplary embodiment in some variations.

In a further variant of a reflector 120 with a grating structure 196, which is shown as an example in FIG. 4c, the part 115 formed from the frequency-converting medium has a reflector side 112 extending substantially in a geometric plane 132, wherein this has a structuring corresponding to the grating structure 196.

In particular, the fact that the reflector side extends substantially in the geometric plane 132 is to be understood as meaning that, with respect to the macroscopic reflection of the radiation field, the reflector side 112 extends in the geometric plane 132 and, for example, with respect to the normal to the geometric plane 132, the angle of incidence of the incident radiation field is equal to the angle of reflection of the reflected radiation field.

In particular, the reflector 120 has a plurality of layers 198 which, together with the structured reflector side 112 of the part 115 formed from the frequency-converting medium, form the grating structure 196.

Preferably, the layers 198 extending substantially parallel to the geometric plane 132 have raised and recessed regions in a direction at least approximately perpendicular to the geometric plane 132, wherein the raised regions each engage in the recessed regions of the next-adjacent layer to fill the volume. The part 115 formed from the frequency-converting medium also has corresponding raised and recessed regions on its reflector side 112, wherein its raised regions engage in a volume-filling manner in recessed regions of the next-adjacent layer 198.

For example, the recessed regions in the part 115 formed from the frequency-converting medium are formed by grooves extending parallel to the geometric plane 132, wherein the grooves are etched, for example.

The structure formed in the reflector side 112 continues accordingly in the subsequent layers 198.

In particular, the layers 198 in this variant also have alternating high and low refractive indices.

Here, the grating structure 196 is configured to reflect at least the radiation field components involved in the frequency conversion and to provide them with the matched phase relationship to one another.

In particular, the grating structure 196 in all these variants is formed in the sub-wavelength range of the radiation fields involved in the frequency conversion.

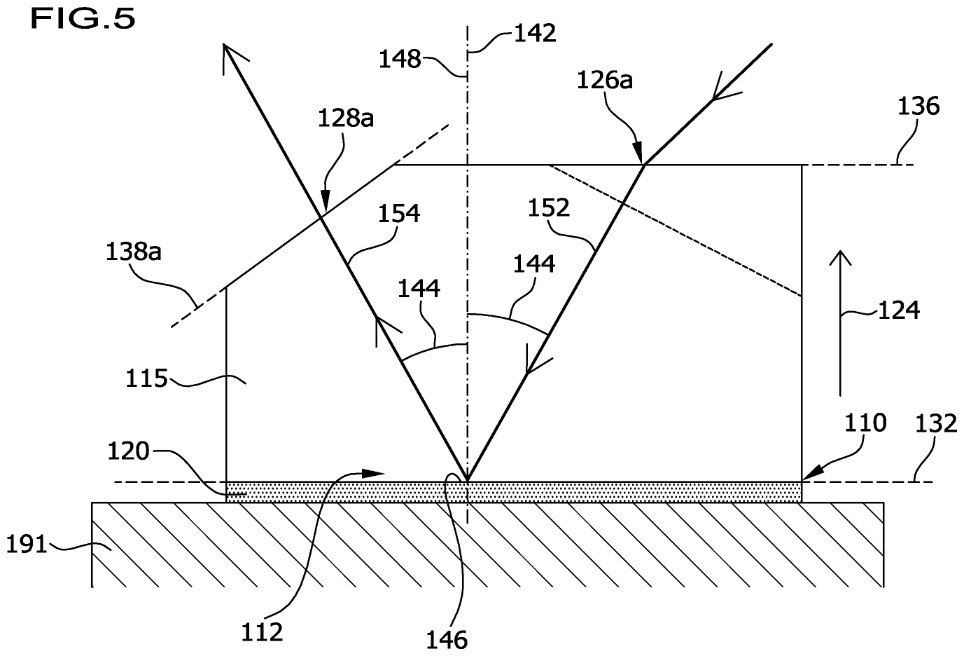

In another exemplary embodiment, which is shown by way of example in FIG. 5, those elements and features which are formed at least substantially identically and/or fulfil at least substantially the same basic function as in the first exemplary embodiment and its variants are provided with the same reference sign as in the first exemplary embodiment and, with regard to the embodiment thereof, reference is made in full to the explanations in conjunction with the first exemplary embodiment, unless otherwise explained below. In particular, if special reference is to be made to an alternative embodiment in this exemplary embodiment, a suffix “a” characterizing this exemplary embodiment is added to a corresponding reference sign.

Also in this exemplary embodiment, a frequency conversion body 110 includes a part 115 formed of a frequency-converting medium and a reflector 120 such that a radiation field propagating along an incident branch 152 through the frequency-converting medium impinges on the reflector 120 and is reflected by the reflector 120 such that the reflected radiation field propagates along a reflected branch 154 through the frequency-converting medium.

In this exemplary embodiment, an entry side 126a, at which the radiation field enters the frequency conversion body 110 along the defined optical path, and an exit side 128a, at which the radiation field exits the frequency conversion body 110 along the defined optical path, are provided opposite the reflector 120 in a direction of extent 124. In particular, the direction of extent 124 runs at least approximately perpendicular to a lateral extent of the frequency conversion body 110.

In this exemplary embodiment, however, it is provided that the surfaces on the entry side 126a and on the exit side 128a run obliquely to one another.

For example, the surface at the entry side 126a through which the radiation field enters the frequency conversion body 110 extends at least approximately in a geometric plane 136 that is at least approximately parallel to a geometric plane 132 of the reflector surface 146.

By contrast, the surface on the exit side 128a, for example, through which the radiation field exits from the frequency conversion body 110, extends at least approximately in a geometric plane 138a, which runs obliquely to the geometric planes 136 of the entry side 126a and the geometric plane 132 of the reflector side 112.

In particular, the surface of the exit side 128a runs in such a way that losses are reduced when the radiation field passes through this surface, for example the geometric plane 138a runs at least approximately perpendicular to the propagation direction of the exiting radiation field.

In a variant of the exemplary embodiment, the surface on the entry side 126a, in particular a geometric plane in which this surface substantially extends, runs obliquely to the geometric plane 132 of the reflector side 112 and/or obliquely to the direction of extent 124, in particular in such a way that losses are reduced when the radiation field enters the entry side 126a. For example, this surface, in particular the geometric plane 136 thereof, runs at least approximately perpendicular to the propagation direction of the incoming radiation field.

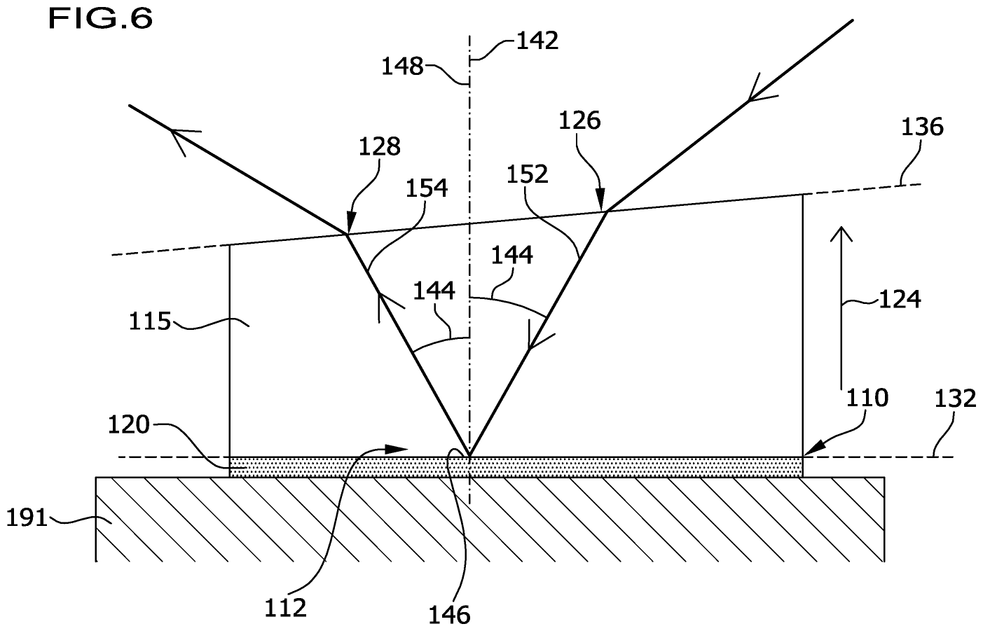

In a variant of the exemplary embodiment, which is shown by way of example in FIG. 6, the surface on the entry side 126a and the surface on the exit side 128a run on a common side of the frequency conversion body 110 and these surfaces run obliquely to the surface on the opposite side of the frequency conversion body 110.

Preferably, the surface forming the surfaces on the entry side 126a and on the exit side 128a runs at a small angle to the surface on the opposite side, which is, for example, less than or equal to 5° and/or greater than or equal to 0.5°. In particular, geometric planes 136, 132, in which at least approximately the surfaces of the inlet and exit sides or the opposite side run, run at the small angle, which is in particular less than or equal to 5° and/or greater than or equal to 0.5°.

For example, an advantage of this is that radiation undesirably reflected at the entry side 126a propagates in a different direction than the radiation field propagating along the optical path and exiting at the exit side 128a, so that these radiation fields are spatially separated.

Preferably, all further elements and features in this exemplary embodiment and its variants are at least partially formed as in the exemplary embodiment explained above or in an exemplary embodiment explained below, so that reference is made in full to the corresponding embodiments, in particular with regard to the formation of the reflector 120, the course of the radiation field along the optical path, in particular the course of the incident and reflected branch relative to the marked axis 142 and/or the cooling system with at least one cooling body 191, 192.

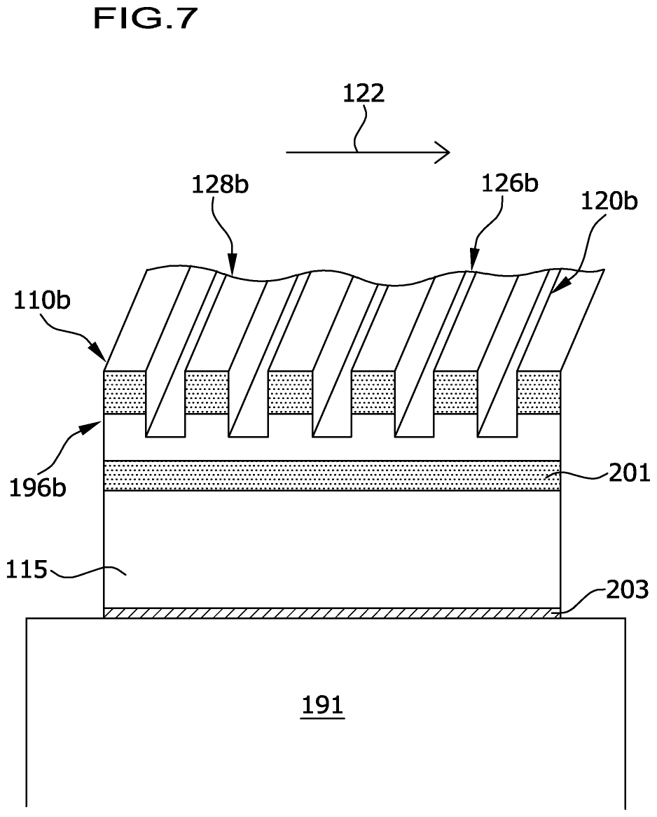

In a further exemplary embodiment, which is shown by way of example in FIG. 7, those elements and features which are at least substantially the same and/or which fulfil at least substantially the same basic function as elements and features of another exemplary embodiment are provided with the same reference signs and, unless anything supplementary and/or deviating is explained below, reference is made in full to the explanations in conjunction with the further exemplary embodiments.

In this exemplary embodiment, a frequency conversion body 110b has a grating structure 196b on a side forming an entry side 126b and exit side 128b, and preferably a waveguide structure 201 is formed behind the grating structure 196b with respect to a direction of incidence of incident radiation field components involved in a frequency conversion, for example radiation field components 182e and/or 184e and/or 186e.

Here, the grating structure 196b has portions with a high and low refractive index arranged alternately next to one another in the lateral direction 122 of the frequency conversion body 110b, wherein the portions with a low refractive index are formed, for example, at least partially from longitudinally extending depressions.

In some favorable variants, elongate depressions formed at least in the frequency-converting medium at least partially form the grating structure 196b.

In other advantageous variants, the grating structure comprising one or more layers is applied to the frequency-converting medium.

With regard to advantageous embodiments, in particular with regard to the geometry of the grating structure and/or the formation of a plurality of layers, reference is also made to the preceding explanations in conjunction with the grating structure 196, wherein these formations can also be provided accordingly in this exemplary embodiment, wherein the parameters, for example with regard to a period of the grating and/or a ratio of the width of the portion with a high refractive index to the period and/or the thickness of one or more layers and/or the depth of depressions, are adapted and optimized in this exemplary embodiment, in particular with regard to the reflection and/or the waveguide structure lying underneath and the associated guidance of the light.

Here, in some favorable variants, a reflector 120b is formed at least substantially by the grating structure 196b, wherein incident radiation field components are reflected by the interaction with the grating structure 196b and are subjected to frequency conversion by the penetration into the frequency-converting medium, so that frequency-converted radiation field components are contained in the reflected radiation field.

In other favorable variants, a reflective layer 203 is also formed behind the frequency-converting medium with respect to a direction of incidence and also forms the reflector 120b, so that radiation field components penetrating into the frequency-converting medium are at least also reflected by the reflective layer 203. It is thus provided that the frequency-converting medium is arranged between the grating structure 196b and the reflective layer 203.

In this case, interaction of the incident radiation field with the frequency conversion body 110b is such that, at least on a macroscopic scale, the radiation field is reflected with respect to an at least substantially flat reflector surface 146b and thus, during reflection, the radiation field is at least not substantially widened or centered on a focal point.

In addition, preferably all further elements and features in the exemplary embodiments explained above and their variants are at least partially formed as in another of the exemplary embodiments explained above and below, so that reference is made in full to the explanations in conjunction with the other exemplary embodiments, in particular with regard to further details regarding the formation of the reflector 120, the course of the radiation field along the optical path, in particular the course with respect to a marked axis and, for example, the course of the incident and/or reflected branch at a frequency conversion angle to the marked axis 142, and/or a front-side optical body 192 and/or the cooling system with at least one cooling body 191, 192.

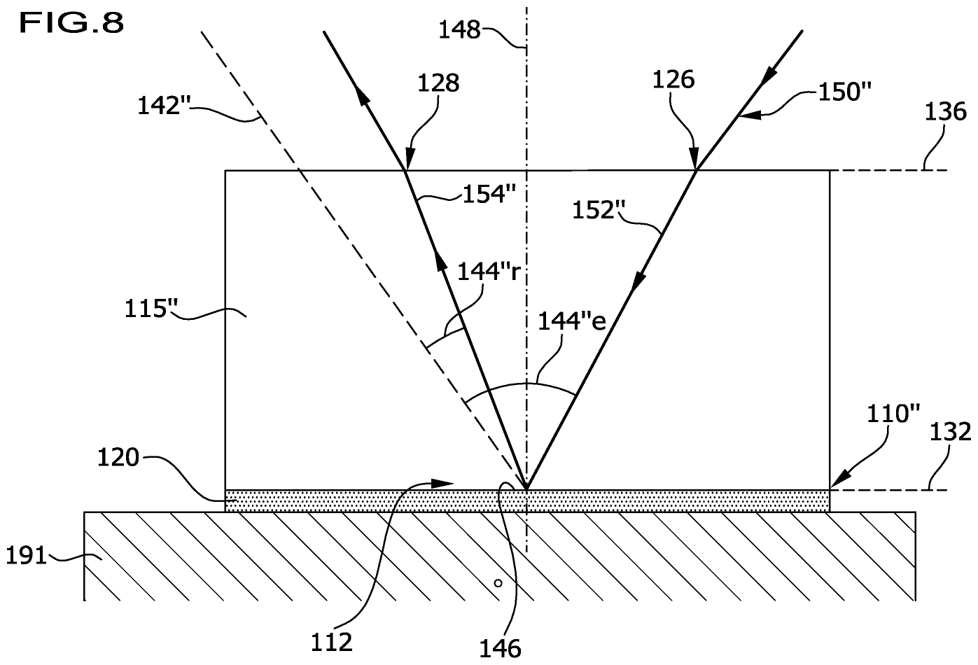

In a further exemplary embodiment, which is shown by way of example in FIG. 8, those elements and features which are at least substantially the same and/or which fulfil at least substantially the same basic function as elements and/or features of one of the preceding exemplary embodiments are provided with the same reference signs and, unless otherwise explained below, reference is made in full to the above explanations.

In particular, if special reference is to be made to an alternative embodiment in this exemplary embodiment, two additional lines are added to the reference signs to identify this exemplary embodiment.

In this exemplary embodiment too, an optical path is defined, wherein a radiation field enters a frequency conversion body 110″ along this optical path at an entry side 126 and propagates along an incident branch 152″ through a frequency-converting medium and impinges on a reflector 120 of the frequency conversion body 110″ and is reflected there, and the radiation field propagates along a reflected branch 154″ through the frequency-converting medium and lastly exits the frequency conversion body 110″ again at an exit side 128.

In this exemplary embodiment, the frequency conversion body 110″ is formed in such a way that a marked axis 142″ of the frequency-converting medium thereof runs obliquely to a normal 148″ of a reflector surface 146 of the reflector 120 in such a way that the incident branch 152″ runs at an angle 144″e to the marked axis 142″, which is different from the angle 144″r at which the outgoing branch 154″ runs to the marked axis 142″.

For example, the part 115″ formed from the frequency-converting medium is formed from a non-linear optical crystal which is cut in such a way that the surface of the crystal on the reflector side 112 runs at least approximately in a geometric plane 132, wherein this surface and the geometric plane 132 run obliquely to the marked axis 142″.

Here, the formation of the frequency conversion body 110 and the portion of the optical path 150″ through it, in particular an entry angle on the entry side 126 and an exit angle on the exit side 128, is formed in such a way that the angle 144″r between the reflected branch 154″ and the marked axis 142″ corresponds to a required frequency conversion angle.

On the other hand, the angle 144″e between the incident branch 152″ and the marked axis 152″ preferably deviates from a frequency conversion angle in such a way that the non-linear processes do not take place for the radiation field propagating along this incident branch 152″ and no frequency conversion occurs.

In particular, the reflector 120 is again formed as a dielectric mirror comprising a plurality of layers or as a reflector comprising a grating.

Since in this exemplary embodiment it is provided that no frequency conversion takes place along the incident branch 152″, it is not necessary for the reflector 120 to maintain a phase relationship between different radiation field components, since the frequency conversion only takes place after the reflection. Thus, the reflector can be formed structurally more simply, since in particular there is only the requirement to effectively reflect the irradiated components.

Preferably, at least most of the other elements and features are formed as in one of the exemplary embodiments explained above, so that with regard to the embodiment thereof, for example the formation of the frequency conversion body as a thin body and/or the embodiment of the entry side 126 and the exit side 128 and/or a front-side optical body 192 and/or a cooling system with at least one cooling body 191, 192, reference is made in full to the explanations in conjunction with the exemplary embodiments explained above.

In particular, it is also provided in this exemplary embodiment that in some variants the surface on the entry side 126 and the surface on the exit side 128 extend substantially in a same surface, which preferably runs in a geometric plane 136, which in particular runs at least approximately parallel to the geometric plane 132 of the intermediate surface of the reflector side.

In other variants of the exemplary embodiment, the surfaces of the entry side 126 and the exit side 128 run obliquely to one another, wherein in some variations one of the two surfaces runs at least approximately parallel to the intermediate surface on the reflector side 112 and in other variants both surfaces run obliquely to the intermediate surface on the reflector side 112. With regard to these different embodiments, reference is accordingly made in full to the explanations in conjunction with the corresponding exemplary embodiments and variants thereof.

In all the exemplary embodiments explained above, a coating is preferably provided on the inlet and exit sides 126, 128 of the frequency conversion body.

In particular, an anti-reflection coating is provided to at least reduce losses when the radiation field enters and exits.

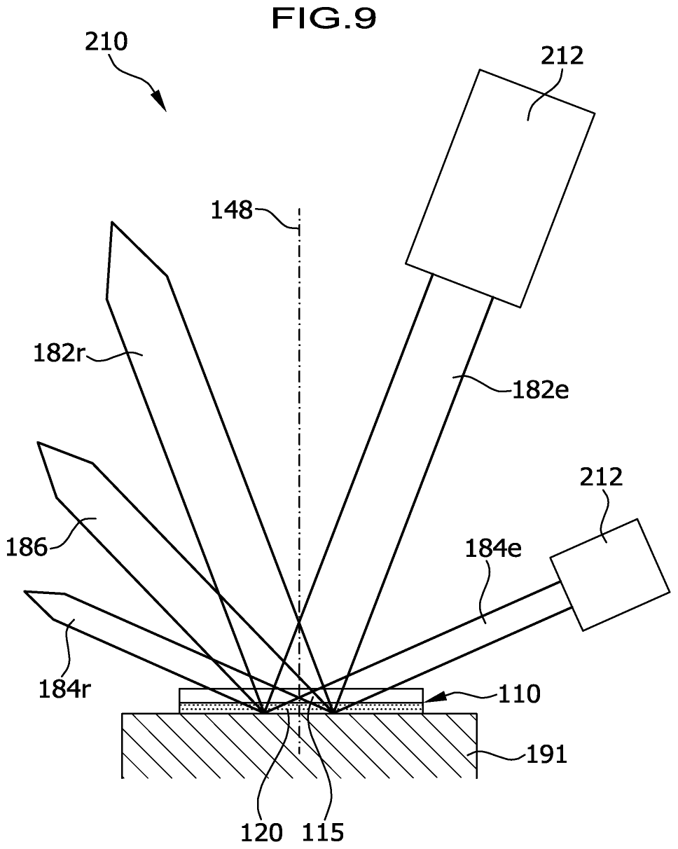

In addition to a frequency conversion body 110, which is preferably formed in accordance with one of the exemplary embodiments explained above, an exemplary embodiment of a radiation field provision device denoted as a whole as 210, which is shown by way of example in FIG. 9, comprises at least one radiation field source 212, which generates a radiation field. The radiation field propagates along an optical path 150 defined by the radiation field provision device 210, for which purpose, for example, the radiation field provision device 210 comprises a system of optical elements. The radiation field propagating along the optical path 150 enters the frequency conversion body 110 at an entry side, propagates through the frequency-converting medium, is reflected at the reflector 120, propagates further through the frequency-converting medium and lastly exits the frequency conversion body 110 again.

In particular, the radiation field provision device 210 comprises a plurality of radiation sources 212, namely one radiation field source 212 in each case, which generates a respective radiation field component required for the frequency conversion, for example incident radiation field components 182e and 184e. For example, the radiation field provision device 210 thus comprises two radiation field sources 212, one of which generates a signal component and the other an idler component, or one of which generates a pump component and the other a signal component. In yet other variants, the radiation field provision device 210 comprises only one radiation field source 212 which generates the required pump component.

In particular, the one radiation field source 212 or the multiple radiation field sources 212 each comprise a resonator and thus generate an amplified radiation field, in particular a laser radiation field, which propagates along the optical path 150 towards the frequency conversion body 110 and passes through it.

The frequency conversion body 110 is thus penetrated by the corresponding radiation field components, wherein the radiation field components overlap in the frequency conversion body 110 and a common penetration area is created. Frequency conversion thus takes place at least on one branch of the optical path, as discussed in the exemplary embodiments explained above.

If the individual radiation field components are irradiated at different angles to the normal 148 of the reflector 120, the generated frequency-converted radiation field component, for example a radiation field component 186, propagates through the frequency conversion body 110 at a different angle to the normal 148 and no further separation of the radiation field components, which propagate in different directions, is subsequently required in order to further utilize the frequency-converted radiation field component.

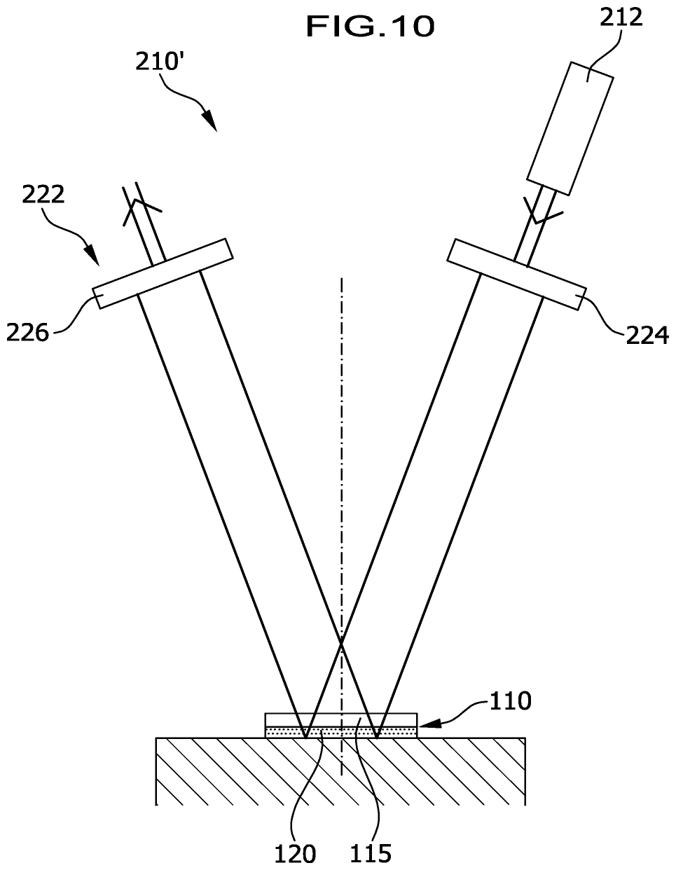

In another exemplary embodiment of a radiation field provision device 210′, which is shown by way of example in FIG. 10, this comprises a frequency conversion body 110, which is formed in particular in accordance with one of the exemplary embodiments explained above, and at least one resonator 222.

In particular, a portion of an optical path 150 is defined by a system of optical elements, wherein, for example, the system of optical elements comprises at least two end mirrors 224 and 226 between which the optical path is defined within the resonator 222.

In this exemplary embodiment of the radiation field provision device 210′, the frequency conversion body 110 is arranged within the resonator 222, for example in the portion of the optical path running between the two end mirrors 224 and 226.

In particular, in this exemplary embodiment, the radiation field provision device 210′ also comprises at least one radiation field source 212 for at least one radiation field component required for the frequency conversion, in particular for a pump component and/or a signal component of the radiation field, wherein this radiation field component generated by this radiation field source is introduced into the resonator 222, for example through a partially permeable end mirror 224.

In addition, the resonator 222 also comprises a decoupling element, for example one of the two end mirrors, in this case the end mirror 226, is partially transparent, so that the generated frequency-converted radiation field component can be at least partially decoupled from the resonator 222 and made available for further use.

For example, this radiation field provision device 210′ is particularly favorable for parametric generation.

In variants of this exemplary embodiment of a radiation field provision device 210′, it is configured for other types of frequency conversion, in particular for one of the frequency conversion processes described at the outset.

A frequency conversion body is likewise arranged in a resonator, wherein the resonator is resonant for at least one of the radiation field components involved in the frequency conversion, i.e. it is resonant for the pump component and/or for the idler component and/or for the signal component of the radiation field, for example.

For example, one advantage of this is that the intensity of the at least one resonant radiation field component is increased and/or the resonant radiation field component passes through the frequency conversion body more often and thus a rate of frequency conversion can be increased.

In a further exemplary embodiment of a radiation field provision device 210′″, a resonator 222′″ is likewise provided, in which a laser-active medium 232 and a frequency conversion body 110 are arranged.

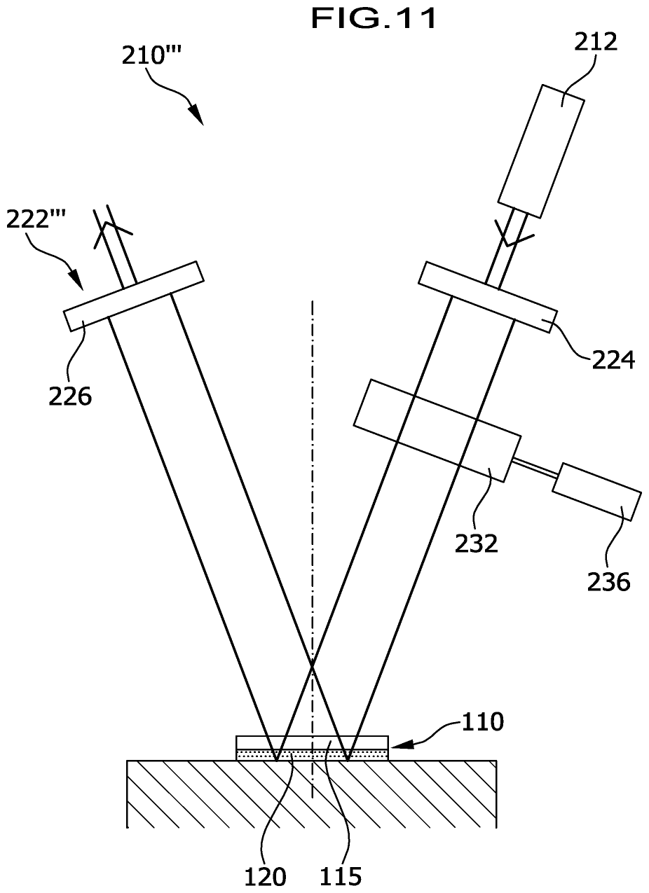

FIG. 11 shows an example of this type of arrangement for such a radiation field provision device 210′″.

In this exemplary embodiment too, the resonator 222′″ is resonant for at least one radiation field component involved in the frequency conversion.

By means of the laser-active medium 232, at least one radiation field component involved in the frequency conversion, in particular the at least one radiation field component resonating in the resonator, is generated and/or amplified.

In particular, the resonator 222″ has two end mirrors 224, 226, as in the exemplary embodiments explained above, wherein at least one of these end mirrors is a partially transparent end mirror as a decoupling element.

In particular, a pump device 236 is also provided for pumping the laser-active medium 232. For example, the pump device 236 is configured for electrically pumping the laser-active medium 232 or for optically pumping the laser-active medium 232.

In all other respects, further embodiments and features of this exemplary embodiment are as in one of the preceding exemplary embodiments, so that reference is made in full to the explanations provided in conjunction with those.

Preferably, all further elements and features of these exemplary embodiments of the radiation field provision device, in particular with regard to the embodiment of the frequency conversion body 110, the embodiment of the part 115 comprising the frequency-converting medium and of the reflector 120, the embodiment of the portion of the optical path 150 running through the frequency conversion body 110 and, for example, of a cooling system, are at least partially formed as in one of the exemplary embodiments described above, in particular in conjunction with FIGS. 1 to 8 described above, so that reference is made in full to the above explanations.

### LIST OF REFERENCE SIGNS

100 radiation field provision device
110 frequency conversion body
112 reflector side
115 part comprising frequency-converting medium
120 reflector
122 lateral direction of the frequency conversion body
124 direction of extent of the frequency conversion body
126 entry side
128 exit side
132 geometric plane of the reflector side
136 geometric plane of the entry and/or exit side
138a oblique geometric plane
142 marked axis
144e, r angle of the incident or reflected branch to the marked axis
146 reflector surface
148 normal to the reflector side
150 optical path
152 incident branch
154 reflected branch
162, 164, 166 layer assemblies
168 direction of penetration
172 uppermost layer
176 , 178 phase matching layer
182e,r/184e,r/186e,r incident, reflected radiation field component that is involved in frequency conversion
191 cooling body
192 front-side optical body
193 abutting side of the front-side optical body
194 opposite side of the front-side optical body
195 lateral side of the front-side optical body
196 grating structure
197 coating
198 layer(s)
199 buffer layer
201 waveguide structure
203 reflective layer
210, 210′ radiation field provision device
212 radiation source
222 resonator
224, 226 end mirror
232 laser-active medium
236 pump device

What is claimed is:

1. A radiation field provision device, in which an optical path for a radiation field is defined, comprising a frequency conversion body, wherein the frequency conversion body is partially formed from a frequency-converting medium and a reflector.

2. The radiation field provision device in accordance with claim 1, wherein in the case of a radiation field propagating along the optical path, a radiation field component, which is involved in a frequency conversion and is comprised by the radiation field, is at least partially converted by a frequency conversion in the frequency-converting medium into a radiation field component with a different frequency.

3. The radiation field provision device in accordance with claim 1, wherein a frequency conversion takes place at least along a reflected branch of the optical path.

4. The radiation field provision device in accordance with claim 1, wherein a frequency conversion takes place at least along an incident branch of the optical path.

5. The radiation field provision device in accordance with claim 1, wherein along one branch of the portion of the optical path running in the frequency conversion body no frequency conversion takes place in the case of a radiation field propagating along the optical path.

6. The radiation field provision device in accordance with claim 1, wherein an incident branch and a reflected branch of the optical path run symmetrically to a marked axis of the frequency-converting medium of the frequency conversion body.

7. The radiation field provision device in accordance with claim 1, wherein an incident branch and a reflected branch of the optical path run asymmetrically with respect to a marked axis of the frequency-converting medium of the frequency conversion body.

8. The radiation field provision device in accordance with claim 1, wherein the reflector is attached to the frequency-converting medium.

9. The radiation field provision device in accordance with claim 1, wherein the reflector is formed at least partially from the frequency-converting medium.

10. The radiation field provision device in accordance with claim 1, wherein a reflection surface of the reflector extends at least approximately perpendicularly to a marked axis of the frequency-converting medium of the frequency conversion body.

11. The radiation field provision device in accordance with claim 1, wherein a reflection surface of the reflector runs obliquely to a marked axis of the frequency-converting medium of the frequency conversion body.

12. The radiation field provision device in accordance with claim 1, wherein the reflector provides a reflected radiation field in which radiation field components involved in the frequency conversion fulfil conditions adapted for the frequency conversion.

13. The radiation field provision device in accordance with claim 1, wherein the reflector is formed in such a way that phase relationships between at least the radiation field components involved in the frequency conversion remain at least substantially unchanged by the reflector.

14. The radiation field provision device in accordance with claim 1, wherein the reflector comprises multiple layers.

15. The radiation field provision device in accordance with claim 1, wherein the reflector comprises at least one phase matching layer for phase matching at least one radiation field component involved in the frequency conversion.

16. The radiation field provision device in accordance with claim 1, wherein the reflector (120) comprises an optical grating.

17. The radiation field provision device in accordance with claim 1, wherein a surface of the frequency conversion body at one of an entry side, at which the optical path enters the frequency conversion body, and/or an exit side, at which the optical path exits the frequency conversion body, runs parallel to an intermediate surface on a reflector side of the part comprising the frequency-converting medium.

18. The radiation field provision device in accordance with claim 1, wherein a surface of the frequency conversion body at one of an entry side, at which the optical path enters the frequency conversion body, and/or an exit side, at which the optical path exits the frequency conversion body, runs obliquely to an intermediate surface on a reflector side of the part comprising the frequency-converting medium.

19. The radiation field provision device in accordance with claim 1, wherein a surface of the frequency conversion body at its entry side, at which the optical path enters the frequency conversion body, and a surface of the frequency conversion body at its exit side, at which the optical path exits the frequency conversion body, run obliquely to one another.

20. The radiation field provision device in accordance with claim 1, wherein the frequency conversion body (110) has a coating on at least one of a surface at an entry side and/or a surface at an exit side.

21. The radiation field provision device in accordance with claim 1, wherein the frequency conversion body is a thin body.

22. The radiation field provision device in accordance with claim 1, wherein the geometric embodiment of the frequency conversion body is such that an one-dimensional heat conduction takes place in it.

23. The radiation field provision device in accordance with claim 1, wherein at least one cooling body is arranged on a side of the frequency conversion body on which the reflector is formed.

24. The radiation field provision device in accordance with claim 1, wherein a front-side optical body is arranged on a side of the frequency conversion body forming at least on of an entry side and/or an exit side.

25. The radiation field provision device in accordance with claim 1, wherein the frequency conversion body is arranged outside at least one resonator.

26. The radiation field provision device in accordance with claim 1, wherein the frequency conversion body is arranged within at least one resonator.
